(19) United States
(12) Patent Application Publication
(10) Pub. No.: US 2015/0215449 A1
(43) Pub. Date: Jul. 30, 2015

(54) INCOMING CALL MANAGEMENT DEVICE, MANAGEMENT SERVER, TELEPHONE TERMINAL, CONTROLLER, COMMUNICATION SYSTEM, INCOMING CALL CONTROL METHOD AND PROGRAM

(71) Applicant: BIGLOBE Inc., Tokyo (JP)

(72) Inventors: Kyoji Hirata, Tokyo (JP); Kazuya Furukawa, Tokyo (JP)

(73) Assignee: BIGLOBE INC., Tokyo (JP)

(21) Appl. No.: 14/600,750

(22) Filed: Jan. 20, 2015

(30) Foreign Application Priority Data
Jan. 29, 2014 (JP) 2014-014027

(51) Int. Cl. H04M 3/38; H04M 3/436; H04M 3/53; H04M 3/42

(52) U.S. Cl. CPC H04M 3/38; H04M 3/42042; H04M 3/436; H04M 3/53

(57) ABSTRACT

An object of the present invention is to forestall phone crimes such as hoax call and phone fraud. When a call detection section 110 detects a call, a message transmission section 120 transmits a first message to a calling terminal corresponding to the call originator, and if a first response is transmitted from the calling terminal in response to the first message, a connection control section 130 connects the calling terminal to a receiving terminal corresponding to a receiver of the call, and if a second response is transmitted from the calling terminal in response to the first message, the connection control section 130 rejects a connection of the calling terminal to the receiving terminal corresponding to the call receiver. If the second response is transmitted from the calling terminal in response to the first message, a registration section 140 registers a telephone number of the calling terminal.

### BACKGROUND OF THE INVENTION

1. Field of the Invention

The present invention relates to an incoming call management device, a management server, a telephone terminal, a controller, a communication system, an incoming call control method and a program all for controlling incoming calls.

2. Related Art

In recent years, the number of crimes using telephone such as hoax calls and phone frauds, is increasing. In order to forestall such a crime (hereinafter referred to as a nuisance call) and for user not to be a victim, various countermeasures have been suggested.

As one of these countermeasures, a system in which telephone conversation is recorded after announcing a calling terminal that the contents of the conversation are to be recorded has been suggested, for example, in Japanese Patent Laid-Open Publication No. 2011-119953 (Patent Document 1).

### SUMMARY OF THE INVENTION

In the system described in Patent Literature 1, no information is recorded with respect to a call originator with which no voice communication has been made. Many of persons making nuisance calls do not agree to the contents of the aforementioned announcement, and probably hang up before making a voice communication. Therefore, there is a problem in which it is impossible to forestall a nuisance call made by such a person.

An object of the present invention is to provide an incoming call management device, a management server, a telephone terminal, a controller, a communication system, an incoming call control method and a program capable of solving the above-described problem.

The incoming call management device of the present invention includes: a call detection section detecting a voice communication call; a message transmission section transmitting a first message to a calling terminal corresponding to an originator of the call when the call detection section detects the call; a connection control section connecting the calling terminal to a receiving terminal corresponding to a receiver of the call if a first response is transmitted from the calling terminal in response to the first message transmitted by the message transmission section, and rejects is connection of the calling terminal to the receiving terminal if a second response is transmitted from the calling terminal in response to the first message transmitted by the message transmission section; and a registration section registering a telephone number of the calling terminal if the second response is transmitted from the calling terminal in response to the first message transmitted by the message transmission section.

Besides, the management server of the present invention includes the aforementioned incoming call management device, and is connected, through a communication network, to a plurality of telephone terminals including the calling terminal and the receiving terminal for relaying the voice communication call.

Besides, the controller of the present invention includes the aforementioned incoming call, management device, and is connected between the receiving terminal and a communication network.

Furthermore, the telephone terminal of the present invention includes the aforementioned incoming call management device, and is capable the receiving terminal.

Besides, the communication system of the present invention is a communication system including a plurality of telephone terminals and a management server connected to the plurality of telephone terminals via a communication network, in which the management server includes: a call detection section detecting a voice communication call from any of the telephone terminals; a message transmission section transmitting a first message to a calling terminal corresponding to an originator of the call, out of the plurality of telephone terminals, when the call detection section detects the call; a connection control section connecting the calling terminal to a receiving terminal corresponding to a receiver of the call, out of the plurality of telephone terminals, if a first response is transmitted from the calling terminal in response to the first message transmitted by the message transmission section, and rejects a connection of the calling terminal to the receiving terminal if a second response is transmitted from the calling terminal in response to the first message transmitted by the message transmission section; and a registration section registering a telephone number of the calling terminal if the second response is transmitted from the calling terminal in response to the first message transmitted by the message transmission section.

The communication system of the present invention is a communication system including a plurality of telephone terminals, a management server connected to the plurality of telephone terminals via a communication network, and a controller connected between one telephone terminal out of the plurality of telephone terminals and the communication network, in which the controller includes: a call detection section detecting a voice communication call from any of the plurality of telephone terminals to a receiving terminal corresponding to the telephone terminal connected to the controller out of the plurality of telephone terminals; a message transmission section transmitting a first message to a calling terminal corresponding to an originator of the call out of the plurality of telephone terminals when the call detection section detects the call; a connection control section connecting the calling terminal to the receiving terminal if a first response is transmitted from the calling terminal in response to the first message transmitted by the message transmission section, and rejects a connection of the calling terminal to the receiving terminal if a second response is transmitted from the calling terminal in response to the first message transmitted by the message transmission section; and a registration section registering a telephone number of the calling terminal if the second response is transmitted from the calling terminal in response to the first message transmitted by the message transmission section.

The communication system of the present invention is a communication system including a plurality of telephone terminals and a management server connected to the plurality of telephone terminals via a communication network for relaying voice calls between the plurality of telephone terminals, in which one telephone terminal includes: a call detection section detecting a voice communication call to the telephone terminal from any one of the other telephone terminals out of the plurality of telephone terminals; a message transmission section transmitting a first message to a calling terminal corresponding to an originator of the call when the call detection section detects the call; a connection control section connecting the calling terminal to the telephone terminal if a first response is transmitted from the calling terminal in response to the first message transmitted by the message transmission section, and rejects a connection of the calling terminal to the telephone terminal if a second response is transmitted from the calling terminal in response to the first message transmitted by the message transmission section; and a registration section registering a telephone number of the calling terminal if the second response is transmitted from the calling terminal in response to the first message transmitted by the message transmission section.

The incoming call control method of the present invention includes processing for detecting a voice communication call; processing for transmitting a first message to a calling terminal corresponding to an originator of the call if the call is detected; processing for connecting the calling terminal to a receiving terminal corresponding to a receiver of the call if a first response is transmitted from the calling terminal in response to the transmitted first message; processing for rejecting a connection of the calling terminal to the receiving terminal if a second response is transmitted from the calling terminal in response to the transmitted first message; and processing the registering a telephone number of the calling terminal if the second response has been transmitted from the calling terminal in response to the first message.

Besides, the program of the present invention is a program for causing a computer to execute: a procedure for detecting a voice communication call; a procedure for transmitting a first message to a calling terminal corresponding to an originator of the call if the call is detected; a procedure for connecting the calling terminal to a receiving terminal corresponding to a receiver of the call if a first response is transmitted from the calling terminal in response to the transmitted first message; a procedure for rejecting a connection of the calling terminal to the receiving terminal if a second response is transmitted from the calling terminal in response to the transmitted first message; and a procedure for registering a telephone number of the calling terminal if the second response is transmitted from the calling terminal in response to the first message.

As described above, according to the present invention, a person can be prevented from becoming a victim of a nuisance call.

### BRIEF DESCRIPTION OF THE DRAWINGS

FIG. 1 is a diagram illustrating a first embodiment of an incoming call management device of the present invention.

FIG. 2 is a diagram of an exemplary telephone number list registered in a registration section of FIG. 1.

FIG. 3 is a flowchart for explaining an incoming call control method performed in the incoming call management device of FIG. 1.

FIG. 4 is a diagram illustrating a second embodiment of the incoming call management device of the present invention.

FIG. 5 is a diagram illustrating an exemplary internal configuration of the incoming call management device of FIG. 4.

FIG. 6 is a diagram illustrating an example of recording information stored in a recording section of FIG. 5.

FIG. 7 is a diagram illustrating an exemplary telephone number list, stored in a registration section of FIG. 5, in which a telephone number is correlated with identification information.

FIG. 8 is a flowchart for explaining a first example of processing performed by the incoming call management device of FIG. 4 from detection of a call until registration of a telephone number.

FIG. 9 is a sequence diagram for explaining processing performed, during the processing described with reference to FIG. 8, between the incoming call management device and a calling terminal if a connection control section determines in step S13 that neither a first response nor a second response has been transmitted from the calling terminal within a prescribed time.

FIG. 10 is a sequence diagram for explaining processing performed, during the processing described with reference to FIG. 8, between the incoming call management device and telephone terminals if the connection control section determines in step S14 that a response transmitted from the calling terminal is the first response.

FIG. 11 is a sequence diagram for explaining processing performed, during the processing described with reference to FIG. 8, between the incoming call management device and the calling terminal if the connection control section determines in step S14 that the response transmitted from the calling terminal is the second response.

FIG. 12 is a flowchart for explaining a second example of the processing performed by the incoming call management device of FIG. 4 from the detection of a call until the registration of a telephone number.

FIG. 13 is a sequence diagram for explaining processing performed, during the processing described with reference to FIG. 12, between the incoming call management device and the telephone terminals if the connection control section determines in step S56 that no voice has been transmitted from the calling terminal within a prescribed time after establishing a voice communication.

FIG. 14 is a flowchart for explaining a third example of the processing performed by the incoming call management device of FIG. 4 from the detection of a call until the registration of a telephone number.

FIG. 15 is a sequence diagram for explaining processing performed, during the processing described with reference to FIG. 14, between the incoming cell management device and the telephone terminal if the connection control section determines in step S86 that the response transmitted tram a receiving terminal is a third response.

FIG. 16 is a flowchart for explaining processing, performed in an incoming call control method employed in the incoming call management device of FIG. 4, for registering a telephone number in a connection block list.

FIG. 17 is a flowchart for explaining processing, performed in the incoming call control method employed in the incoming call management device of FIG. 4, for rejecting a connection from a telephone terminal by the incoming call management device.

FIG. 18 is a diagram illustrating a third embodiment of the incoming call management device of the present invention.

FIG. 19 is a diagram illustrating an exemplary internal configuration of a management server of FIG. 18.

FIG. 20 is a sequence diagram for explaining processing performed, during the processing performed by the incoming call management device described with reference to FIG. 8, between the management server and the calling terminal if the connection control section determines in step S13 that neither the first response nor the second response has been transmitted within a prescribed time.

FIG. 21 is a sequence diagram for explaining processing performed, during the processing performed by the incoming call management device described with reference to FIG. 8, between the management server and the calling terminal if the connection control section determines in step S14 that the response transmitted from the calling terminal is the first response.

FIG. 22 is a sequence diagram for explaining processing performed, during the processing performed by the incoming call management device described with reference to FIG. 8, between the management server and the calling terminal if the connection control section determines in step S14 that the response transmitted from the calling terminal is the second response.

FIG. 23 is a sequence diagram for explaining processing performed, during the processing performed by the incoming call management device described with reference to FIG. 12, between the management server and the telephone terminals if the connection control section determines in step S56 that no voice has been transmitted from the calling terminal within a proscribed time after establishing a voice communication.

FIG. 24 is a sequence diagram for explaining processing performed, during the processing performed by the incoming call management device described with reference to FIG. 14, between the management server and the telephone terminals if the connection control section determines in step S86 that the response transmitted from the receiving terminal is the third response.

FIG. 25 is a diagram illustrating a fourth embodiment of the incoming call management device of the present invention.

FIG. 26 is a diagram illustrating exemplary connection of a controller of FIG. 25.

FIG. 27 is a diagram illustrating an exemplary internal configuration of the controller of FIG. 25.

FIG. 28 is a sequence diagram for explaining processing performed, during the processing performed by the incoming call management device described with reference to FIG. 8, between the controller and the calling terminal if the connection control section determines in step S13 that neither the first response nor the second response has been transmitted within a prescribed time.

FIG. 29 is a sequence diagram for explaining processing performed, during the processing performed by the incoming call management device described with reference to FIG. 8, between the controller and the telephone terminals if the connection control section determines in step S14 that the response transmitted from the calling terminal is the first response.

FIG. 30 is a sequence diagram for explaining processing performed, during the processing performed b the incoming call management device described with reference to FIG. 8, between the controller and the calling terminal if the connection control section determines in step S14 that the response transmitted from the calling terminal is the second response.

FIG. 31 is a sequence diagram for explaining processing performed, during the processing performed by the incoming call management device described with reference, to FIG. 12, between the controller and the telephone terminals if the connection control section determines in stop S56 that no voice has been transmitted from the calling terminal within a prescribed time after establishing a voice communication.

FIG. 32 is a sequence diagram for explaining processing performed, during the processing performed by the incoming call management device described with reference to FIG. 14, between the controller and the telephone terminals if the connection control section determines in step S86 that the response transmitted from the receiving terminal is the third response.

FIG. 33 is a diagram illustrating a fifth embodiment of the incoming call management device of the present invention.

FIG. 34 is a diagram illustrating an exemplary internal configuration of a telephone terminal that can be a receiving terminal of FIG. 33.

FIG. 35 is a flowchart for explaining a first example of processing performed by the incoming call management device of the telephone terminal of FIG. 34 from detection of a call until registration of a telephone number.

FIG. 36 is a flowchart for explaining a second example of the processing performed by the incoming call management device of the telephone terminal of FIG. 34 from the detection of a call until the registration of a telephone number.

FIG. 37 is a flowchart for explaining a third example of the processing perforated by the incoming call management device of the telephone terminal of FIG. 34 from the detection of a call until the registration of a telephone number.

### DESCRIPTION OF THE EMBODIMENTS

Now, preferred embodiments of the present invention will be described with reference to the accompanying drawings.

### First Embodiment

FIG. 1 is a diagram illustrating a first embodiment of an incoming all management device of the present invention.

The incoming call management device 100 of the present embodiment includes, as illustrated in FIG. 1, a call detection section 110, a message transmission section 120, a connection control section 130, and a registration section 140. It is noted that the incoming call management device 100 is connected to a plurality of telephone terminals for relaying calls between the telephone terminals.

The call detection section 110 detects a voice communication call from a telephone terminal. In other words, the call detection section 110 detects a call made from a telephone terminal. This detection rosy be performed by a usual method.

If the call detection section 110 detects a voice communication call, the message transmission section 120 transmits a first message to a telephone terminal corresponding to the originator of the call (that is, a calling terminal). This first message is a message for informing that telephone conversation is to be recorded. Specifically, the first message is a message for confirming whether or not the caller agrees to the recording of the telephone conversation, such as “This voice call is to be recorded. Do you agree to the recording?” Besides, this message may be output by voice or output to be displayed with characters or the like in the calling terminal.

If a first response is transmitted from the calling terminal in response to the first message transmitted by the message transmission section 120, the connection control section 130 connects the calling terminal to a telephone terminal corresponding to a receiver of the call (i.e., a receiving terminal). This first response is a message corresponding to the agreement to the recording of the telephone conversation. Alternatively, if a second response is transmitted from the calling terminal in response to the first message transmitted by the message transmission section 120, the connection control section 130 does not connect the calling terminal to the telephone terminal corresponding to the receiver of the call (i.e., the receiving terminal) (namely, rejects the connection). This second response is a message corresponding to disagreement to the recording of the telephone conversation.

If the second response is transmitted from the calling terminal in response to the first message transmitted, by the message transmission section 120, the registration section 140 registers the telephone number of the calling terminal.

Here, the message transmission section 120 preferably transmits, in transmitting the first message, information for causing the caller to select, in the calling terminal having received, the first message, whether he/she “agrees” or “disagrees”. For example, the message transmission section 120 may include, in the first message, a message “Please push the “1” button if you agree, and push the “2” button if you disagree”. Alternatively, the message transmission section 120 may include information for displaying, in a display screen of the calling terminal, images of icons or the like corresponding to “agreement” and “disagreement”. Further alternatively, the message transmission section 120 may include, in the first message, a message “please say “yes” if you agree, and say “no” if you disagree”, so that the connection control section 130 may discriminate the voice of “yes” or “no” emitted by the caller in response to the message. Incidentally, in the case where the connection control section 130 discriminates a voice of the caller emitted in response to the message, if it discriminates the voice as a voice different from one corresponding to the agreement, such as “yes” or “I agree”, it may be determined that the voice corresponds to the disagreement. When the caller selects “agree” or “disagree” in accordance with such selecting means, a response corresponding to the selection is transmitted from the calling terminal to the incoming call management device 100. In this manner, the connection control section 130 can discriminate whether the response transmitted from the calling terminal is the first response or the second response. Transmission of a message and transmission of a response to the message described below are performed similarly. Besides, each message transmitted from the message transmission section 120 is precedently set in the message transmission section 120 and can be externally added/changed.

It is noted that the first message may be a message different from the message for confirming whether or not the recording of the telephone conversation is agreed. It may be, for example, a message for giving a prescribed warning to a person calling from the calling terminal and confirming whether or not he/she still demands the connection, such as “When connected to the receiver, the nuisance call detection function is activated.”

FIG. 2 is a diagram of an exemplary telephone number list registered in the registration section 140 of FIG. 1.

In the registration section 140 of FIG. 1, telephone numbers of calling terminals that have transmitted the second response in response to the first message transmuted by the message transmission section 120 are registered in the form of a list. This list can be used later as a list of telephone numbers of telephone terminals presumed to have been used for making nuisance calls.

Now, an incoming call control method employed in the incoming call management device 100 of FIG. 1 will be described.

FIG. 3 is a flowchart for explaining the incoming call control method employed in the incoming call management device 100 of FIG. 1.

First, when the call detection section 110 detects a voice call (step S1), the message transmission section 120 transmits the first message to a calling terminal of the voice call (step S2). Here, the calling terminal corresponding to the call originator of the voice call detected by the call detection section 110 is recognized by a usual method using a telephone number or the like of the call originator included in a call request signal of the voice call. Thereafter, the connection control section 130 determines whether a response transmitted from the calling terminal is the first response (of agreement) or the second response (of disagreement) (step S3).

If it is determined that the response transmitted from the calling terminal is the first response, the connection control section 130 connects the calling terminal to a receiving terminal corresponding to a receiver of the voice call (step S4). On the other hand, if it is determined that the response transmitted from the calling terminal is the second response, the connection control section 130 does not connect the calling terminal to the receiving terminal corresponding to the receiver of the voice call (namely, rejects the connection), and the registration section 140 registers a telephone number of the calling terminal (step S5).

Incidentally, if the call detection section 110 detects a call from a telephone terminal whose telephone number is precedently registered by the receiving terminal, the message transmission section 120 may not transmit the first message. In this case, the connection control section 130 connects the telephone terminal having this telephone number to the receiving terminal.

In this manner, when a voice call is detected, the incoming call management device 100 transmits a prescribed message to a call originator, and the voice call is connected only when an affirmative response is received in response to the message, and if a negative response is received, the telephone number of a calling terminal is registered. Thus, a user can be prevented from becoming a victim of a nuisance call.

### Second Embodiment

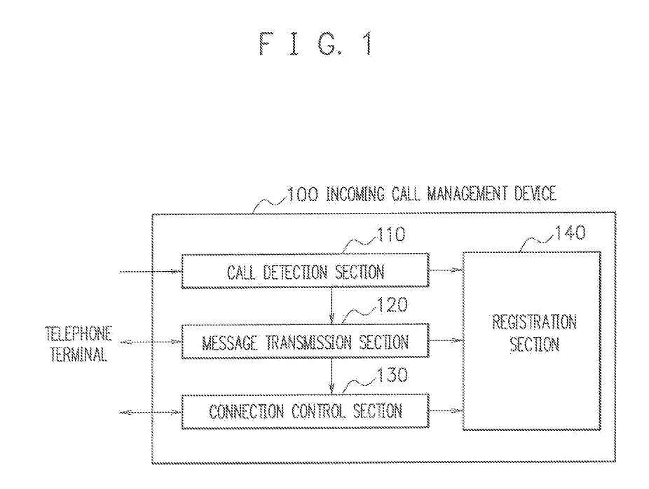

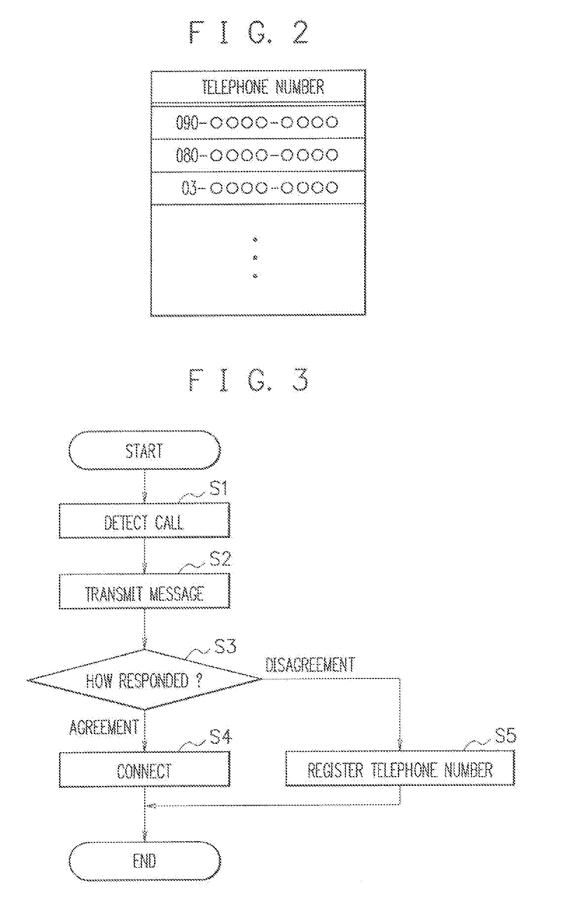

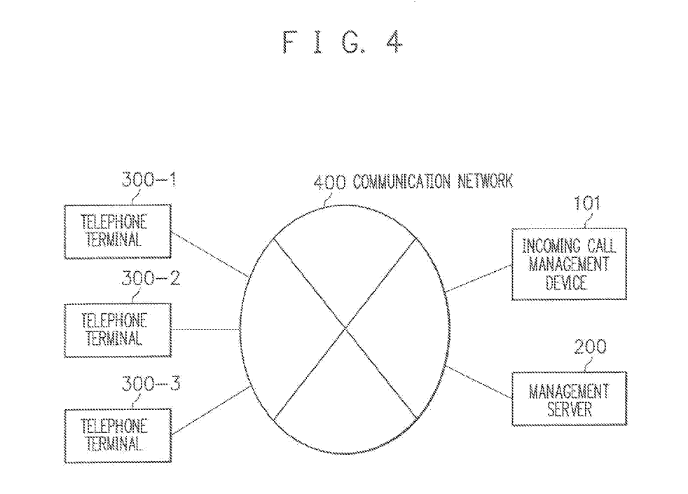

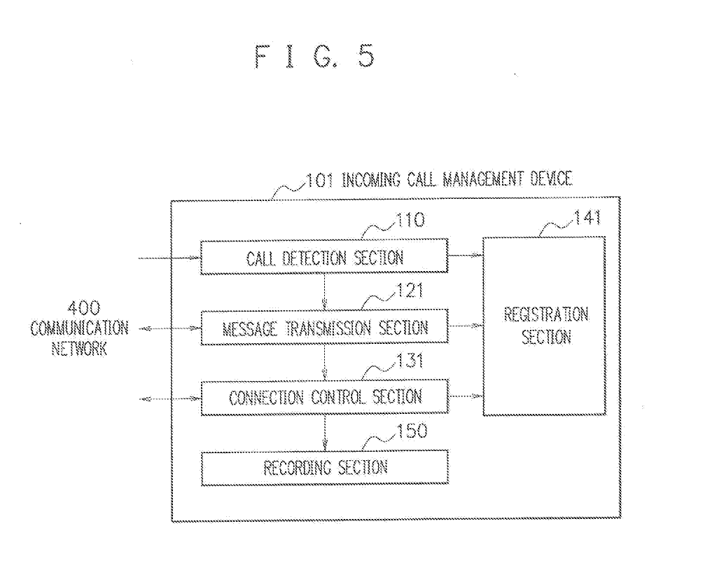

FIG. 4 is a diagram illustrating a second embodiment of the incoming call management device of the present invention.

As illustrated in FIG. 4, a communication system using an incoming can management device 101 is provided with a management server 200, and telephone terminals 300-1 to 300-3. Besides, the incoming call management device 101, the management server 200 and the telephone terminals 300-1 to 300-3 are mutually connected via a communication network 400. Furthermore, although the number of telephone terminals 300-1 to 300-3 is three in the embodiment illustrated in FIG. 4, the number of telephone terminals is not herein specified.

The management server 200 relays voice calls between the telephone terminals 300-1 to 300-3 via the communication network 400. Besides, the management server 200 is a server for providing a prescribed service, and manages telephone terminals of users subscribing the service.

The telephone terminals 300-1 to 300-3 are communication equipment capable of making a voice call. Each of the telephone terminals 300-1 to 300-3 is not limited to a landline telephone but may be any communication equipment such as a cellular phone, a portable terminal, a smart phone or a tablet terminal.

FIG. 5 is a diagram illustrating an exemplary internal configuration of the incoming call management device 101 of FIG. 4.

The incoming call management device 101 of FIG. 4 includes, as illustrated in FIG. 5, a call detection section 110, a message transmission section 121, a connection control section 131, a registration section 141 and a recording section 150. Incidentally, FIG. 5 illustrates merely exemplary principal composing elements pertaining to the present embodiment out of all composing elements of the incoming call management device 101 of FIG. 4.

The call detection section 110 is the same as that described in the first embodiment.

The recording section 150 records telephone conversion by starting recording, when a voice communication is established between any of the telephone terminals 300-1 to 300-3 and terminating the recording when the voice communication is ended. Besides, the recording section 150 stores the recorded telephone conversion with identification information such as an index added for identifying, the recorded telephone conversation. At this point, the recording section 150 may store, as recorded information, the recorded conversation in correlation with information pertaining to the voice call such as the date and time of starting and terminating the recording, the telephone number of a call originator and the telephone number of a call receiver. Besides, the recording section 150 may delete the recorded telephone conversation when a prescribed time has elapsed after the recording. Furthermore, the telephone conversion recorded by the recording section 150 can be externally provided to the management server 200 or the like, so as to be effectively utilized, for example, by using it as evidence when a user becomes a victim of a nuisance call, or by sharing it as information pertaining to a nuisance call.

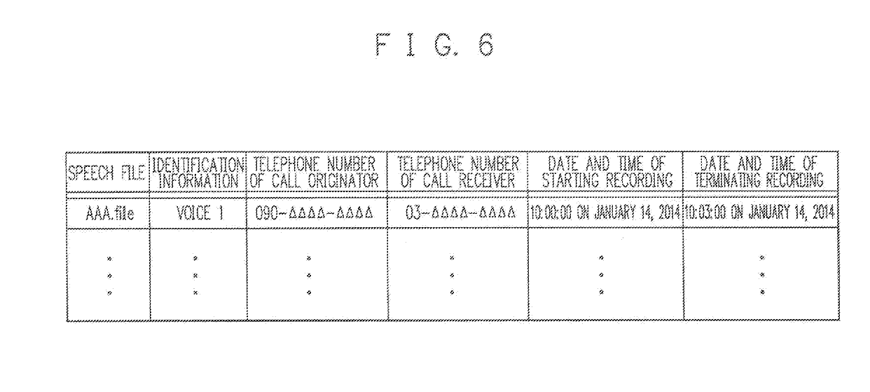

FIG. 6 is a diagram illustrating exemplary recorded information stored in the recording section 150 of FIG. 5.

The recording section 150 of FIG. 5 stores, as illustrated in FIG. 6, a speech file or recorded telephone conversation in correlation with an identification number assigned to the telephone conversation, the telephone number of a call originator, the telephone number of a call receiver, the date and time of starting the recording, and the date and time of terminating the recording.

The message transmission section 121 has the same functions as those of the message transmission section 120 of the first embodiment, and in addition, sends a second message to the receiving terminal if the second response is transmitted from the calling terminal in response to the first message transmitted by the message transmission section 120. This second message is a message for confirming whether or not the call may be connected although the agreement to the recording could not be obtained from the calling terminal.

The connection control section 131 has the same functions as those of the connection control section 130 of the first embodiment, and in addition, after connecting a calling terminal to a receiving terminal among the telephone terminals 300-1 to 300-3, it disconnects the connection if no voice has been transmitted from the calling terminal within a prescribed time after establishing a voice communication between the calling terminal and the receiving terminal. In order to realize this function, the connection control section 131 has a voice recognition function. The connection control section 131 recognizes, by using this voice recognition function, voices used in conversation such as a voice of a human and a computer synthesized voice. Besides, it a third response that the call may be connected is transmitted from the receiving terminal in response to the second message transmitted by the message transmission section 120, the connection control section 131 connects the calling terminal to the receiving terminal. Furthermore, if a telephone number registered by the registration section 141 meets a prescribed condition, the connection control section 131 rejects a connection from a telephone terminal having this telephone number. This condition will be described later.

The registration section 141 has the same functions as those of the registration section 140 of the first embodiment, and in addition, if neither the first response no the second response is transmitted within a prescribed time after the message transmission section 121 transmitted the first message, the registration section 141 registers the telephone number of the calling terminal in a telephone number list. Besides, if the connection is disconnected because no voice has been transmitted from the terminal within a prescribed time after the connection control section 131 connected the calling terminal to the receiving terminal, the registration section 141 registers the telephone number of the calling terminal in the telephone number list.

Furthermore, if a telephone number registered in the telephone number list meets a prescribed condition, the registration section 141 registers the telephone number in a connection block list. Here, some examples of this condition will be described.

### (1) Condition for Registration Interval

When a prescribed time has elapsed after registration of a telephone number in the telephone number list, the registration section 141 deletes the telephone number from the telephone number list. Besides, if a telephone number to be registered has already been registered in the telephone number list, the registration section 141 registers the telephone number in the connection block lists. Specifically, if the interval of the registration of the same telephone number is shorter than the prescribed time, the registration section 141 registers the telephone number in the connection block list.

### (2) Condition for the Number of Registration Times

If a telephone number to be registered has already been registered in the telephone number list, the registration section 141 updates the number of attempts made for the registration of this telephone number. Specifically, if a telephone number to be registered has not been registered in the telephone number list, the registration section 141 registers “1” in the telephone number list in correlation with the telephone number. Thereafter, if this telephone number is to be registered by the registration section 141, the number of registration times “1” registered in correlation with the telephone number is updated to “2”. Then, if the number of registration times registered in the telephone number list exceeds a prescribed threshold value, the registration section 141 registers this telephone number in the connection block list. Specifically, when the number of calls made from a telephone number registered in the telephone number list exceeds a prescribed number, the registration section 141 registers this telephone number in the connection block list.

### (3) Condition for the Number of Registration Times in Prescribed Period

In the condition described above in (2), the registration section 141 resets the number of calls of registration times at a prescribed cycle or timing. Specifically, if the number of calls (i.e., calling frequency) made in a prescribed period from a telephone number registered in the telephone number list exceeds a prescribed threshold value, the registration section 141 registers this telephone number in the connection block list. The registration section 141 may have a plurality of values with respect to each of this cycle and this threshold value, so that the registration section 141 may register the telephone number in the connection block list if any of these conditions for the cycle and threshold value is met.

The registration section 141 may register the telephone number in the connection block list if any of the aforementioned conditions (1) to (3) is met. Besides, the interval of the registration, the number of registration times and the frequency described above are not necessarily the interval of the registration, the number of registration times and the frequency with respect to one telephone number, but may be the interval of the registration, the number of registration times and the frequency with respect to a plurality of telephone numbers in total. For example, the registration section 141 may register, in the connection block list, a telephone number having been registered once each in telephone number lists of five telephone terminals without registering a telephone number having been registered five times in a telephone number list of one telephone terminal. Besides, the registration section 141 may delete a telephone number having been registered in the connection block list when a prescribed time has elapsed after the registration of the telephone number in the connection block list. Alternatively, the registration section 141 may delete all telephone numbers registered in the connection block list at a prescribed cycle or timing.

Furthermore, if the telephone conversation of a call from a telephone terminal with a registered telephone number is recorded by the recording section 150, the registration section 141 registers the telephone number in the telephone number list in correlation with identification information assigned to the recorded telephone conversation.

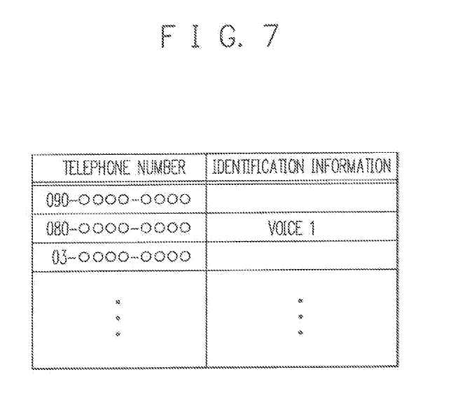

FIG. 7 is a diagram of an exemplified telephone number list in which a telephone number stored in the registration section 141 of FIG. 5 is in correlation with identification information.

The registration section 141 of FIG. 5 stores, as illustrated in FIG. 7, a telephone number registered by the registration section 141 in correlation with an identification number assigned to telephone conversation of a call from the telephone number when the telephone conversation is recorded in the recording section 150. In the example illustrated in FIG. 7, out of three telephone numbers registered in the list, telephone conversation of a call from a telephone terminal having a telephone number “080-AAAA-BBBB” is recorded in the recording section 150 as a voice provided with identification information of “voice 1”.

Incidentally, the telephone number list registered by the registration section 141 is not limited to one illustrated in FIG. 7 but may be, for example, a list in which the identification information of FIG. 7 is not registered, or a list in which a telephone number of a call originator is in correlation with the date and time of registration used for calculating the above-described registration interval, the number of registration times, the telephone number of a call receiver and the like.

Furthermore, if the connection control section 131 does not connect the calling terminal to the receiving terminal, the message transmission section 121 transmits a third message, a ring back one or a busy tone to the calling terminal. Besides, if the connection from the calling terminal is rejected, the message transmission section 121 transmits a third message, a ring back tone or a busy tone to the calling terminal. Furthermore, if a connection is disconnected because no voice is transmitted from a calling terminal within a prescribed time after establishing a voice communication between the calling terminal and the receiving terminal, the message transmission section 121 transmits a third message, a ring back tone or a busy tone to the calling terminal. This third message may be a message that the calling terminal cannot be connected to the receiving terminal, such as “Your call cannot be connected.”, or a message that the call is transferred to another device, such as “Your call is to be connected to the answering service”. At this point, the connection control section 131 may connect the calling terminal to the answering service.

Now, an incoming call control method performed in the incoming call management device 101 of FIG. 4 will be described. First, processing performed by the incoming call management device 101 from the detection of a call until the registration of a telephone number will be described with reference to three examples. Herein, the description will be given on the assumption that the telephone terminal 300-2 makes a call to the telephone terminal 300-1 in the communication system illustrated in FIG. 4.

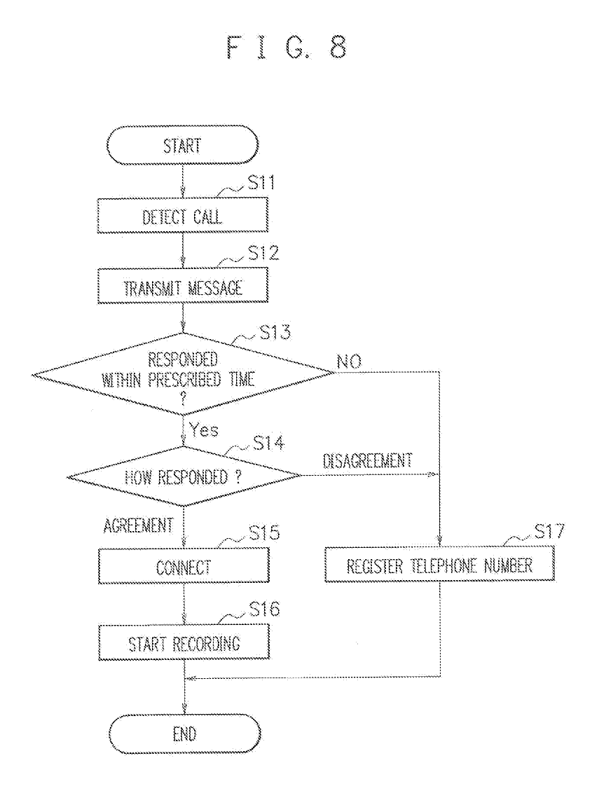

FIG. 8 is a flowchart fiat explaining a first example of the processing performed by the incoming call management device 101 of FIG. 4 from the detection of a call until the registration of a telephone number.

First, when the call detection section 110 detects a voice communication call (step S11), the message transmission section 121 transmits the first message to the telephone terminal 300-2, that is, the calling terminal making the call (step S12). Thereafter, the connection control section 131 determines whether or not the first response (of agreement) or the second response (of disagreement) has been transmitted from the telephone terminal 300-2 within a prescribed time after the message transmission section 121 transmitted the first message (step S13). This prescribed time is information that is precedently stored in the incoming call management device 101 and can be externally set/changed.

If the connection control section 131 determines that the first response or the second response has been transmitted from the telephone terminal 300-2 within the prescribed time, the connection control section 131 determines which of the first response and the second response the transmitted response is (step S14).

If the connection control section 131 determines that the response transmitted from the telephone terminal 300-2 is the first response, the connection control section 131 connects the telephone terminal 300-2 to the telephone terminal 300-1, that is, the receiver of the call (step S15). Thereafter, when a voice communication is established between the telephone terminal 300-2 and the telephone terminal 300-1, the recording section 150 starts to record the voice communication (step S16).

On the other hand, if the connection control section 131 determines in step S13 that neither the first response nor the second response has been transmitted from the telephone terminal 300-2 within the prescribed time, the registration section 141 registers the telephone number of the telephone terminal 300-2 (step S17). In this case, the connection control section 131 does not connect the telephone terminal 300-2 to the telephone terminal 300-1 (namely, rejects the connection). Also when the response transmitted from the telephone terminal 300-2 is determined as the second response in step S14, the connection control section 131 does not connect the telephone terminal 300-2 to the telephone terminal 300-1 (namely, rejects the connection), and the registration section 141 registers the telephone number of the telephone terminal 300-2 in step S17. Incidentally, a case where neither the first response nor the second response has been transmitted from the telephone terminal 300-2 within the prescribed time includes a case where the telephone terminal 300-2 has disconnected the call.

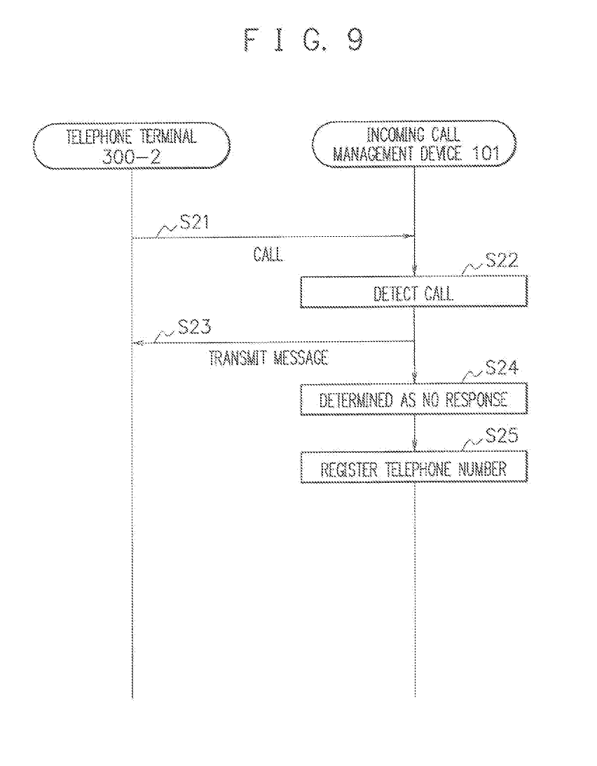

FIG. 9 is a sequence diagram for explaining processing performed, during the processing described with reference to FIG. 8, between the incoming call management device 101 and the telephone terminal 300-2 if the connection control section 131 determines in step S13 that neither the first response nor the second response has been transmitted from the telephone terminal 300-2 within the prescribed time. Incidentally, the transmission/receipt of a message or a response described below is performed via the management server 200, which is not illustrated in FIG. 9.

When the telephone terminal 300-2 makes a call to the telephone terminal 300-1 (step S21), the call detection section 110 detects the call (step S22). Then, the message transmission section 121 transmits the first message to the telephone terminal 300-2 (step S23). Thereafter, if the connection control section 131 determines that neither the first response no the second response has been transmitted from the telephone terminal 300-2 within the prescribed time (step S24), the registration section 141 registers the telephone number of the telephone terminal 300-2 (step S25). In this case, the connection control section 131 does not connect the telephone terminal 300-2 to the telephone terminal 300-1.

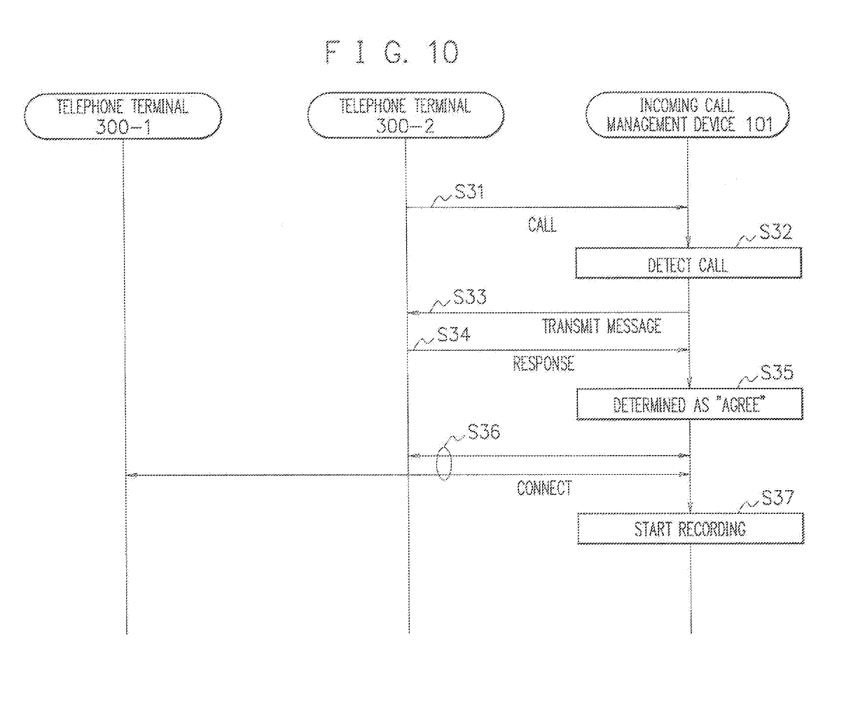

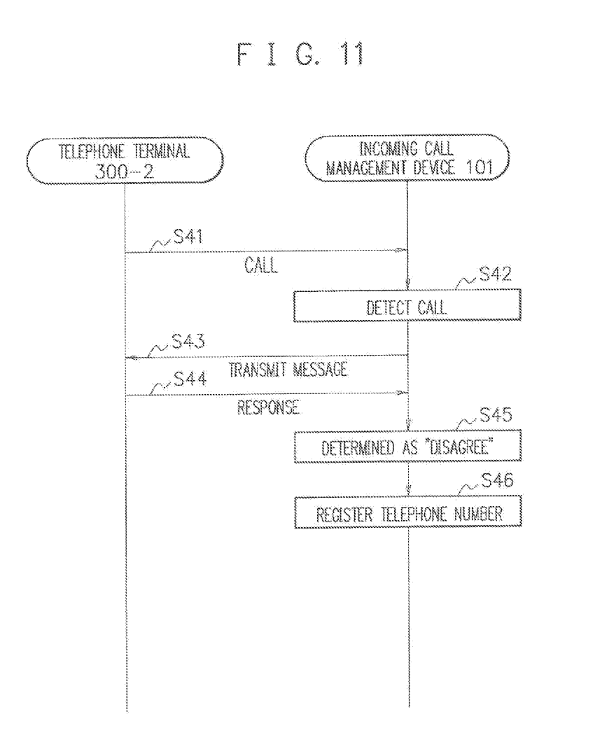

FIG. 10 is a sequence diagram for explaining processing performed, during the processing described with reference to FIG. 8, between the incoming call management device 101 and the telephone terminals 300-1 and 300-2 if the connection control section 131 determines in step S14 that the response transmitted from the telephone terminal 300-2 is the first response. Incidentally, the transmission/receipt of a message or a response described below is performed via the management server 200, which is not illustrated in FIG. 10.

When the telephone terminal 300-2 makes a call to the telephone terminal 300-1 (step S31), the call detection section 110 detects the call (step S32). Then, the message transmission section 121 transmits the first message to the telephone terminal 300-2 (step S33). Thereafter, when the telephone terminal 300-2 transmits the first response corresponding to the “agreement” as the response to the first message (step S34), the connection control section 131 determines that the response transmitted, from the telephone terminal 300-2 is the first response (step S35). Subsequently, the connection control section 131 connects the telephone terminal 300-2 to the telephone terminal 300-1 corresponding to the receiver of the call (step S36). Thereafter, when a voice communication is established between the telephone terminal 300-2 and the telephone terminal 300-1, the recording section 151 starts to record the voice communication (step S37).

FIG. 11 is a sequence diagram for explaining processing performed, during the processing described with reference to FIG. 8, between the incoming call management device 101 and the telephone terminal 300-2 if the connection control section 131 determines in step S14 that the response transmitted from the telephone terminal 300-2 is the second response. Incidentally, the transmission/receipt of a message or a response described below is performed via the management server 200, which is not illustrated in FIG. 11.

When the telephone terminal 300-2 makes a call to the telephone terminal 300-1 (step S41), the call detection section 110 detects the call (step S42). Then, the message transmission section 121 transmits the first message to the telephone terminal 300-2 (step S43). Thereafter, when the telephone terminal 300-2 transmits the second response corresponding to the “disagreement” as the response to the first message (step S44), the connection control section 131 determines that the response transmitted from the telephone terminal 300-2 is the second response (step S45). Then, the registration section 141 registers the telephone number of the telephone terminal 300-2 (step S46). In this case, the connection control section 131 does not connect the telephone terminal 300-2 to the telephone terminal 300-1.

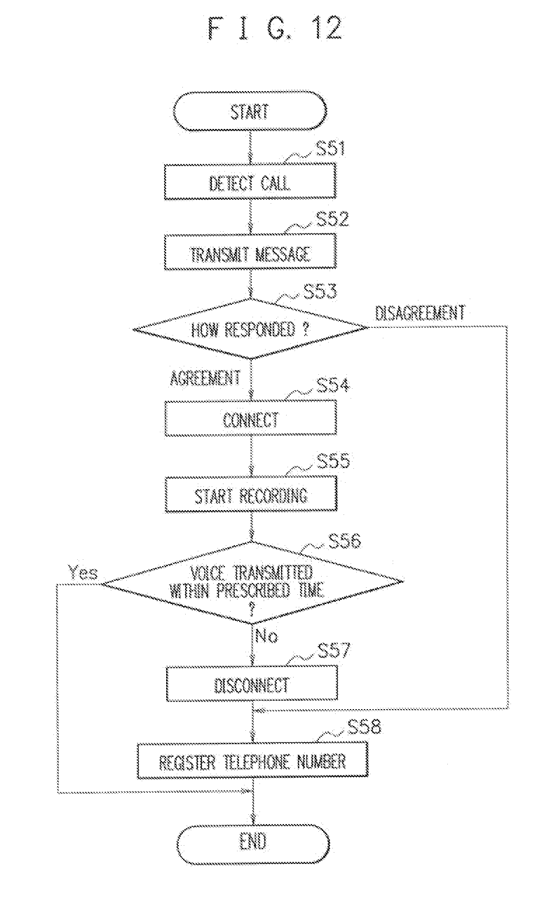

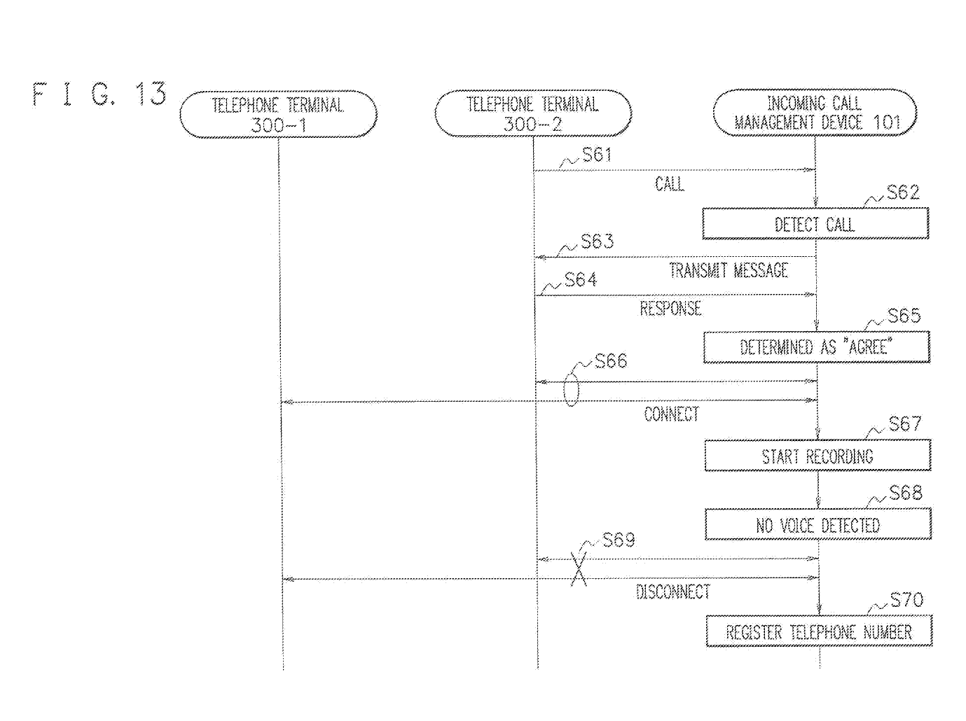

FIG. 12 is a flowchart for explaining a second example of the processing performed by the incoming call management device of FIG. 4 from the detection of a call until the registration of a telephone number.

First, when the call detection section 110 detects a voice communication call (step S51), the message transmission section 121 transmits the first message to the telephone terminal 300-2 corresponding to the call originator (step S52). Thereafter, the connection control section 131 determines which of the first response and the second response the response transmitted from the telephone terminal 300-2 in response to the first message transmitted by the message transmission section 121 is (step S53).

If the response transmitted from the telephone terminal 300-2 is determined as the first response, the connection control section 131 connects the telephone terminal 300-2 to the telephone terminal 300-1 corresponding to the call receiver (step S54). Thereafter, when a voice communication is established between the telephone terminal 300-2 and the telephone terminal 300-1, the recording section 150 starts to record the voice communication (step S35).

After the voice communication is established between the telephone terminal 300-2 and the telephone terminal 300-1, the connection control section 131 determines whether or not a voice has been transmitted from the telephone terminal 300-2 within a prescribed time (step S56). This prescribed lime is precedently stored in the incoming call management device 101 and can be externally set/changed. If the connection control section 131 determines that no voice has been transmitted from the telephone terminal 300-2 within the prescribed time after establishing the voice communication between the telephone terminal 300-2 and the telephone terminal 300-1, the connection control section 131 disconnects the connection between the telephone terminal 300-2 and the telephone terminal 300-1 (step S57). Subsequently, the registration section 141 registers the telephone number of the telephone terminal 300-2 (step S58). Incidentally, the case where it is determined that no voice has been transmitted from the telephone terminal 300-2 within the prescribed time includes a case where the telephone terminal 300-2 has disconnected the call without transmitting a voice. Besides, the case where it is determined that no voice has been transmitted from the telephone terminal 300-2 within the prescribed time may include a case where an unnatural sound other than a human voice, such as an unrecognizable sound or a sound not included in the voice frequency range, has been transmitted from the telephone terminal 300-2.

On the other hand, if it is determined in step S53 that the response transmitted from the telephone terminal 300-2 is the second response, the connection control section 131 does not connect the telephone terminal 300-2 to the telephone terminal 300-1, and the registration section 141 registers the telephone number of the telephone terminal 300-2 in step S58.

Besides, if the connection control section 131 determines in step S56 that a voice has been transmitted from the telephone terminal 300-2 within the prescribed time after establishing a voice communication between the telephone terminal 300-2 and the telephone terminal 300-1, the connection control section 131 does not disconnect the connection between the telephone terminal 300-2 and the telephone terminal 300-1.

FIG. 13 is a sequence diagram for explaining processing performed, during the processing described with reference to FIG. 12, between the incoming call management device 101 and the telephone terminals 300-1 and 300-2 if the connection control section 131 determines in step S56 that no voice has been transmitted from the telephone terminal 300-2 within the prescribed time after establishing the voice communication. Incidentally, the transmission/reception of a message or a response described below is performed via the management server 200, which is not illustrated in FIG. 13.

When the telephone terminal 300-2 makes a call to the telephone terminal 300-1 (step S61), the call detection section 110 detects the call (step S62). Then, the message transmission section 121 transmits the first message to the telephone terminal 300-2 (step S63). Thereafter, when the telephone terminal 300-2 transmits the first response corresponding to the “agreement” as the response to the first message (step S64), the connection control section 131 determines that the response transmitted from the telephone terminal 300-2 is the first response (step S65). Subsequently, the connection control section 131 connects the telephone terminal 300-2 to the telephone terminal 300-1 corresponding to the call receiver (step S66). Thereafter, when a voice communication is established between the telephone terminal 300-2 and the telephone terminal 300-1, the recording section 150 starts to record the voice communication (step S67).

Thereafter, if the connection control section 131 determines that no voice has been transmitted from the telephone terminal 300-2 within the prescribed time after establishing the voice communication between the telephone terminal 300-2 and the telephone terminal 300-1 (step S68), the connection control section 131 disconnects the connection between the telephone terminal 300-2 and the telephone terminal 300-1 (step S69). Subsequently, the registration section 141 registers the telephone number of the telephone terminal 300-2 (step S70).

Incidentally, the processing performed, during the processing described with reference to FIG. 12, between the incoming call management device 101 and the telephone terminals 300-1 and 300-2 if the connection control section 131 determines in step S53 that the response transmitted from the telephone terminal 300-2 is the second response is the same as the processing described with reference to FIG. 11. Besides, the processing performed, during the processing described with reference to FIG. 12, between the incoming call management device 101 and the telephone terminals 300-1 and 300-2 if the connection control section 131 determines in step S56 that is voice has been transmitted from the telephone terminal 300-2 within the prescribed time after establishing the voice communication is the same as the processing described with reference to FIG. 10.

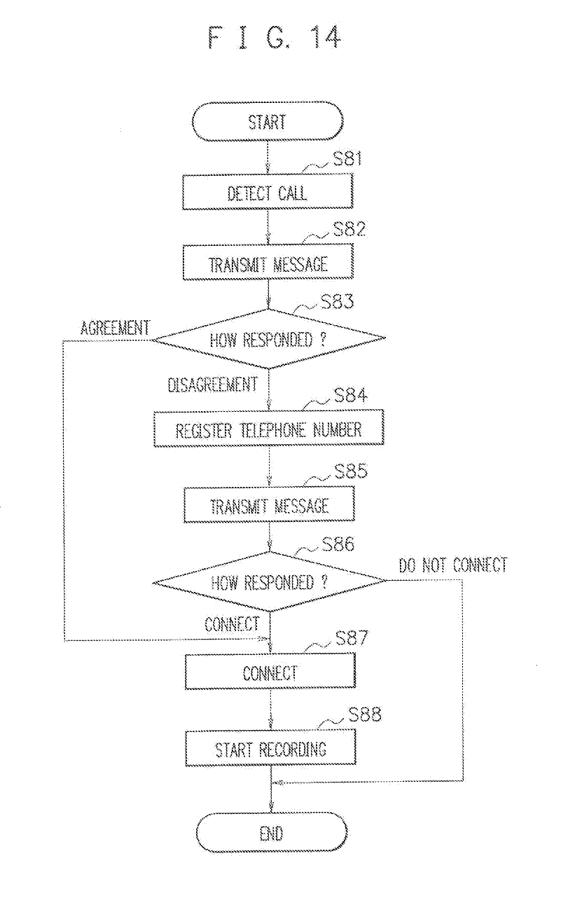

FIG. 14 is a flowchart for explaining a third example of the processing performed by the incoming call management device 101 of FIG. 4 from the detection of a call until the registration of a telephone number.

First, when the call detection section 110 detects a voice communication call (step S81), the message transmission section 121 transmits the first message to the telephone terminal 300-2, that is, the calling terminal making the call (step S82). Thereafter, the connection control section 131 determines which of the first response and the second response a response transmitted from the telephone terminal 300-2 in response to the lust message transmitted by the message transmission section 121 is (step S83).

If the message transmitted from the telephone terminal 300-2 is the second response, the registration section 141 registers the telephone number of the telephone terminal 300-2 (step S84). Subsequently, the message transmission section 121 transmits the second message to the telephone terminal 300-1 corresponding to the receiving terminal of the call (step S85).

Thereafter, the connection control section 131 determines whether or not a response transmitted from the telephone terminal 300-1 in response to the second message is the third message (step S86). If the connection control section 131 determines that the response transmitted from the telephone terminal 300-1 is the third response, the connection control section 131 connects the telephone terminal 300-2 to the telephone terminal 300-1 (step S87). Thereafter when a voice communication is established between the telephone terminal 300-2 and the telephone terminal 300-1, the recording section 150 starts to record the voice communication (step S88).

On the other hand, if the connection control section 131 determines in step S83 that the response transmitted from the telephone terminal 300-2 is the first response, the connection control section 131 connects the telephone terminal 300-2 to the telephone terminal 300-1 corresponding to the call receiver in step S87. Then, when a voice communication is established between the telephone terminal 300-2 and the telephone terminal 300-1, the recording section 150 starts to record the voice communication in step S88.

Besides, if the connection control section 131 determines in step S86 that the response transmitted from the terminal 300-1 is not the third response, namely, the response transmitted from the telephone terminal 300-1 is a response not requiring the connection, the connection control section 131 does not connect the telephone terminal 300-2 to the telephone terminal 300-1. Besides, also when no response has been transmitted from the telephone terminal 300-1 in response to the second message even if a prescribed, time has elapsed since the message transmission section 121 transmitted the second message, the connection control section 131 does not connect the telephone terminal 300-2 to the telephone terminal 300-1.

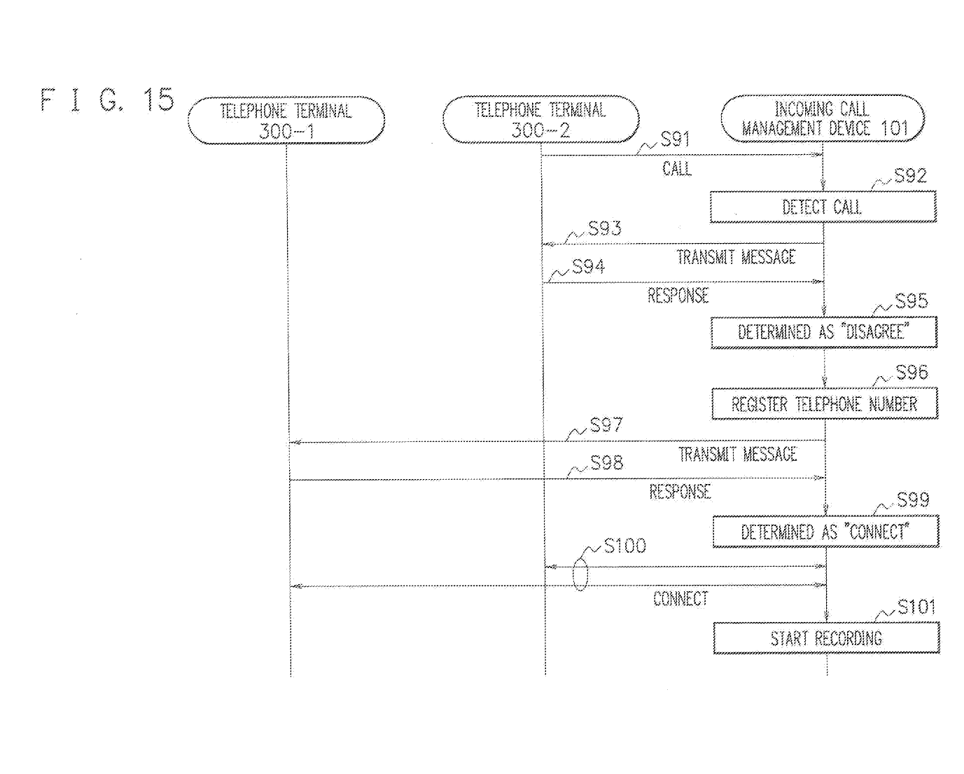

FIG. 15 is a sequence diagram for explaining processing performed, during the processing described with reference to FIG. 14, between the incoming call management device 101 and the telephone terminals 300-1 and 300-2 if the connection control section 131 determines in step S86 that the response transmitted from the telephone terminal 300-4 is the third response. Incidentally, the transmission/receipt of a message or a response described below is performed via the management server 200, which is not illustrated in FIG. 15.

When the telephone terminal 300-2 makes a call to the telephone terminal 300-1 (step S91), the call detection section 110 detects the call (step S92). Then, the message transmission section 121 transmits the first message to the telephone terminal 300-2 (step S93). Thereafter, when the telephone terminal 300-2 transmits the second response corresponding to the “disagreement” as a response to the first message (step S94), the connection control section 131 determines that the response transmitted from the telephone terminal 300-2 is the second response (step S95). Then, the registration section 141 registers the telephone number of the telephone terminal 300-2 (step S96). Subsequently, the message transmission section 121 transmits the second message to the telephone terminal 300-1 (step S97).

Thereafter, when the telephone terminal 300-1 transmits the third response in response to the second message (step S98), the connection control section 131 determines that the response transmitted from the telephone terminal 300-1 in response to the second message is the third message (step S99). Then, the connection control section 131 connects the telephone terminal 300-2 to the telephone terminal 300-1 (step S100). Thereafter, when a voice communication is established between the telephone terminal 300-2 and the telephone terminal 300-1, the recording section 150 starts to record the voice communication (step S101).

Incidentally, the processing performed, during the processing described with reference to FIG. 14, between the incoming call management device 101 and the telephone terminals 300-1 and 300-2 if the connection control section 131 determines in step S83 that the response transmitted from the telephone terminal 300-2 is the first response is the same as the processing described with reference to FIG. 10. Besides, during the processing described with reference to FIG. 14, if the connection control section 131 determines in step S86 that the response transmitted from the telephone terminal 300-1 is not the third response, the processing is terminated without connecting the telephone terminal 300-2 to the telephone terminal 300-1 by the connection control section 131.

Incidentally, after detecting as call by the call detection section 110, the connection control section 131 may reject the call front the calling terminal corresponding to the telephone terminal of the call originator once and then make a call to the calling terminal, so as to transmit the first message from the message transmission section 121 when a user of the calling terminal off-hooks.

Besides, if the call detection section 110 detects a call from a telephone terminal whose telephone number has been precedently registered by a receiving terminal, the message transmission section 121 may not transmit the first message. In this case, the connection control section 131 connects the telephone terminal having that telephone number to the receiving terminal. Besides, in this case, the recording section 150 may not start to record a voice communication.

Now, processing for registering a telephone number in the connection block list in the incoming call control method performed in the incoming call management device 101 of FIG. 4 will be described.

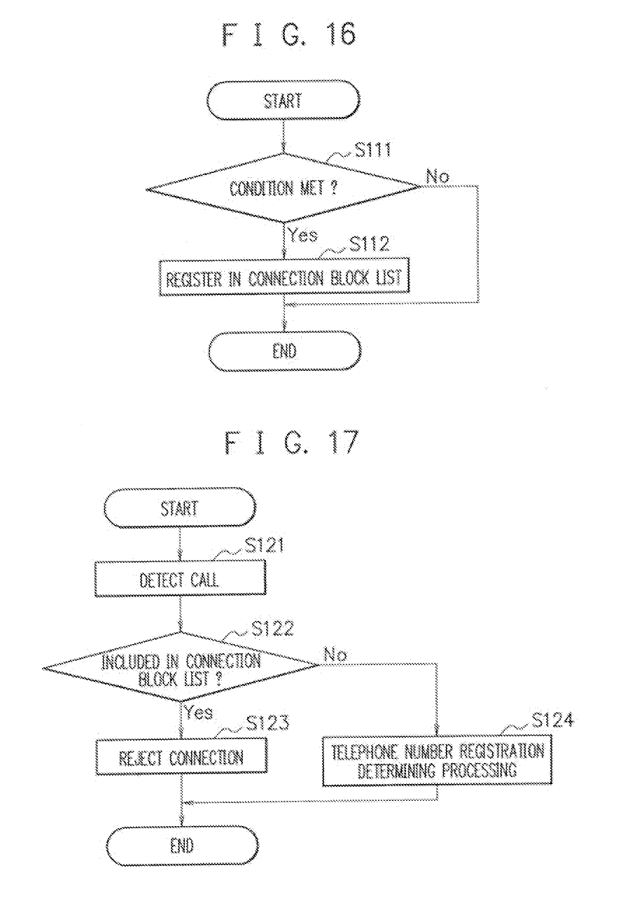

FIG. 16 is a flowchart for explaining the processing for registering a telephone number in the connection block list in the incoming call control method performed in the incoming call management device 101 of FIG. 4.

First, the registration section 141 determines whether or not a telephone number registered in the telephone number list meets a prescribed condition (step S111). This condition has been already described above. If the registration section 141 determines that the telephone number registered in the telephone number list meets the prescribed condition, the registration section 141 registers this telephone number in the connection block list (step S112).

On the other hand, if the registration section 141 determines that the telephone number registered in the telephone number list does not meet the prescribed condition, the registration section 141 does not register the telephone number in the connection block list.

Now, processing for rejecting a connection from any of the telephone terminals 300-1 to 300-3 by the incoming call management device 101 in the incoming call control method performed in the incoming call management device 101 of FIG. 4 will be described. Herein, the description will be given on the assumption that the telephone terminal 300-2 makes a call to the telephone number 300-1 in the communication system of FIG. 4.

FIG. 17 is a flowchart for explaining the processing for rejecting a connection from any of the telephone terminals 300-1 to 300-3 by the incoming call management device 101 in the incoming call control method performed in the incoming call management device 101 of FIG. 4.

First, when the call detection section 110 detects is voice communication call (step S121), the registration section 141 determines whether or not a telephone number of a telephone terminal of the call originator is registered in the connection block list (step S122).

If the registration section 141 determines that the telephone number of the telephone terminal of the call originator is registered in the connection block list, the connection control section 131 rejects the connection from the telephone terminal having this telephone number (step S123). In this case, the message transmission section 121 transmits the third message, a ring back tone or a busy tone to the telephone terminal having the telephone number.

On the other hand, if the registration section 141 determines that the telephone number of the telephone terminal, of the call originator is not registered in the connection block list, the incoming call management device 101 performs telephone number registration determining processing (step S124). This telephone number registration determining processing corresponds to the processing described, with reference to the flowcharts of FIGS. 8, 12 and 14 excluding the processing for detecting a call.

Incidentally, the message transmission section 121 may count the number of detected calls with respect to each of telephone numbers whose calls have been detected by the call detection section 110, so as to transmit, when the panther of detected calls exceeds a prescribed threshold value, the first message to a telephone terminal having the telephone number. Besides, with another condition precedently set, the message transmission section 121 may transmit the first message to a telephone terminal meeting the condition.

Furthermore, the incoming call management device 101 may transmit the telephone number list and the connection block list registered in the registration section 141 to the management server 200 at a prescribed timing, so that these lists can be managed by the management server 200. In this case, the management server 200 performs the processing described with reference to FIGS. 16 and 17. Besides, the management server 200 may delete a telephone number registered in the telephone number list or the connection block list when a prescribed time has elapsed since this telephone number was registered in the telephone number list or the connection block list. Alternatively, the management server 200 may delete all telephone numbers registered in the telephone number list or the connection block list at a prescribed cycle or timing.

Furthermore, the processing described with reference to the flowcharts and the sequence diagrams of FIGS. 8 to 15 is executed on calls made to telephone terminals of contractors having made a contract beforehand, but the processing described with reference to the flowchart of FIG. 17 may be executed on a telephone terminal of a person other than such contractors. In other words, the connection block list created through the processing described with reference to the flowchart of FIG. 15 may be utilized for a call made to a telephone terminal of a person other than the contractors. In this case, the processing of step S124 of FIG. 17 corresponds to processing for allowing the connection between a calling terminal and a receiving terminal.

In this manner, when the incoming call management device 101 detects a voice communication call, a prescribed message is transmitted to the call originator, and if all affirmative response is received in response to the message, the call is connected and a voice communication is recorded. Alternatively, if a negative response is received, the incoming call management device 101 registers the telephone number of the calling terminal. When the registered telephone number meets a prescribed condition, the incoming call management device 101 rejects a connection from the telephone terminal having that telephone number. Owing to this configuration, even if a user of a telephone terminal having an incoming call does not input a telephone number of a call originator by himself/herself, registration of the telephone number is triggered by disagreement of the call originator on the recording of a voice communication, and the connection block list corresponding to a list of telephone numbers of call originators for rejecting a connection can be created. By utilizing this connection block list, a user can be prevented from becoming a victim of a nuisance call.

### Third Embodiment

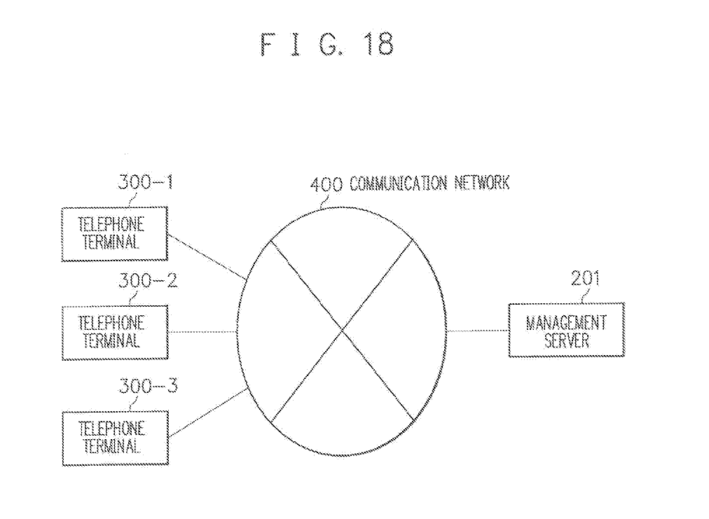

FIG. 18 is a diagram illustrating a third embodiment of the incoming call management device of the present invention. In the present embodiment, a management server is equipped with the incoming call management device. In the present embodiment, the management server may include composing elements of the incoming call management device as hardware, or may store a program for realizing the incoming call management device.

As illustrated in FIG. 18, a communication system of the present embodiment is provided with a management server 201 and telephone terminals 300-1 to 300-3. Besides, the management server 201 is connected to the telephone terminals 300-1 to 300-3 via a communication network 400. Although the number of telephone terminals 300-1 to 300-3 is three in the embodiment illustrated in FIG. 18, the number is not specified.

Each of the telephone terminals 300-1 to 300-3 is communication equipment capable of making a voice call. Each of the telephone terminals 300-1 to 300-3 is not limited to a landline telephone but may be any communication equipment such as a cellular phone, a portable terminal, a smart phone or a tablet terminal.

The management server 201 relays voice calls between the telephone terminals 300-1 to 300-3 via the communication network 400. Besides, the management server 201 is a server for providing a prescribed service, and manages telephone terminals of subscribers to the service.

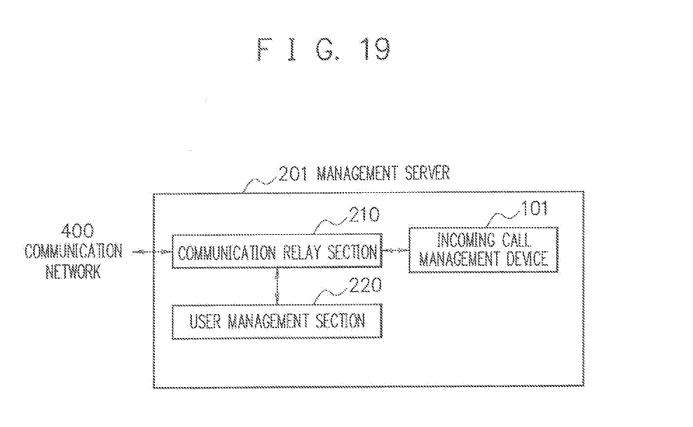

FIG. 19 is a diagram illustrating an exemplified internal configuration of the management server 201 of FIG. 18.

The management server 201 of FIG. 18 includes, as illustrated in FIG. 19, a communication relay section 210, a user management section 220 and an incoming call management device 101. Incidentally, FIG. 19 illustrates merely exemplary principal composing elements pertaining to the present embodiment out of all composing elements of the management server 201 of FIG. 18.

The communication relay section 210 has an interface function with the communication network 400, and relays voice calls between the telephone terminals 300-1 to 300-3.

The user management section 220 manages users subscribing a service provided by the management server 201. For example, the user management section 220 creates/updates, for the management, a database of user identification information, telephone numbers of telephone terminals of users, service use statuses (such as service courses and usage fees) and the like of users of every provided service. Besides, the user management section 220 may store, for the management, recorded information of every user registered in the incoming call management device 101.

The incoming call management device 101 is the same as that described in the second embodiment. Alternatively, as a modification, if a call receiver is a user subscribing the service provided, by the management server 201, user identification information such as a user ID (identification) employed in the service may be used, instead of the telephone number of the call receiver to be registered, in the recording information recorded in the recording section 150. Incidentally, even if a call receiver is not a user subscribing the service provided by the management server 201, the management server 201 may perform the processing described in the second embodiment.

Now, an incoming call control method employed in the embodiment illustrated in FIG. 18 will be described. Herein, the descry:iota will be given on the assumption that the telephone terminal 300-2 makes a call to the telephone terminal 300-1 in the communication system illustrated in FIG. 18. The processing performed by the incoming call management device 101 included in the management server 201 of FIG. 18 is the same as that described in the second embodiment with reference to FIGS. 8, 12, 14, 16 and 17.

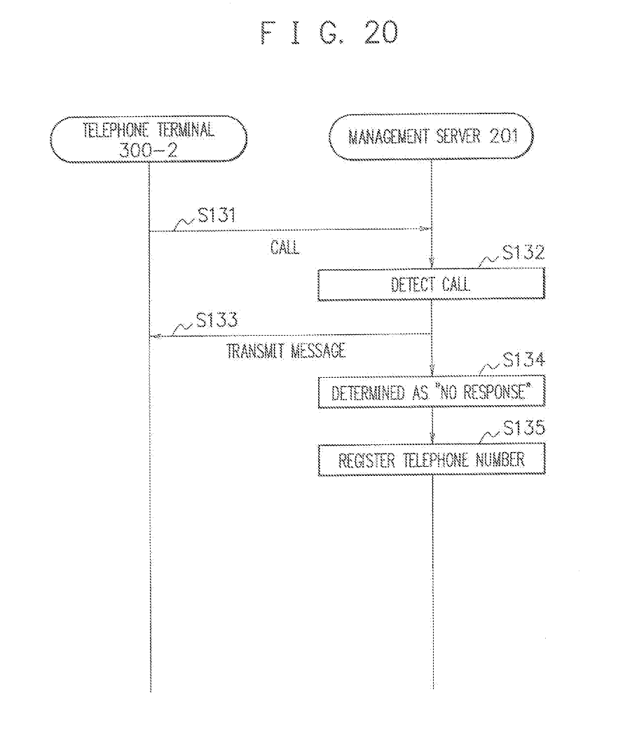

FIG. 20 is a sequence diagram for explaining processing performed, during the processing performed by the incoming call management device 101 described with reference to FIG. 8, between the management server 201 and the telephone terminal 300-2 if the connection control section 131 determines in step S13 that neither the first response nor the second response has been transmitted within the prescribed time.

When the telephone terminal 300-2 makes a call to the telephone terminal 300-1 (step S131), the call detection section 110 of the management server 201 detects the call (step S132). Then, the message transmission section 121 of the management server 201 transmits the first message to the telephone terminal 300-2 (step S133). Subsequently, if the connection control section 131 of the management server 201 determines that neither the first response nor the second response has been transmitted from the telephone terminal 300-2 within the prescribed time (step S134), the registration section 141 of the management server 201 registers the telephone number of the telephone terminal 300-2 (step S135). In this case, the connection control section 131 of the management server 201 does not connect the telephone terminal 300-2 to the telephone terminal 300-1.

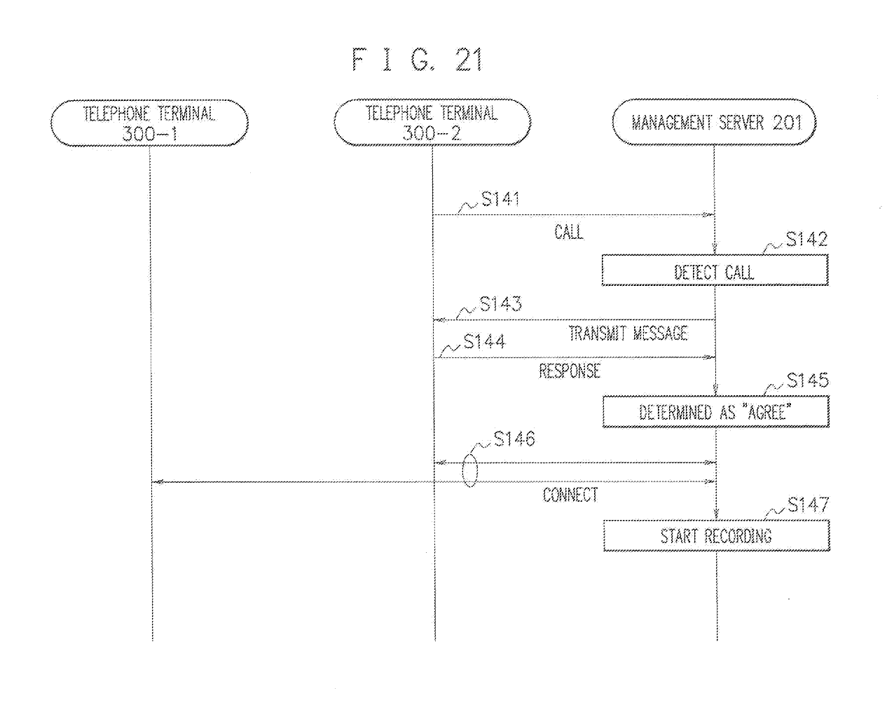

FIG. 21 is a sequence diagram for explaining processing performed, during the processing performed by the incoming call management device 101 described, with reference to FIG. 8, between the management server 201 and the telephone terminals 300-1 and 300-2 if the connection control section 131 determines in step S14 that the response transmitted from the telephone terminal 300-2 is the first response.

When the telephone terminal 300-2 makes a call to the telephone terminal 300-1 (step S141), the call detection section 110 of the management server 201 detects the call (step S142). Then, the message transmission section 121 of the management server 201 transmits the first message to the telephone terminal 300-2 (step S143). Thereafter, if the telephone terminal 300-2 transmits the first response corresponding to the “agreement” as the response to the first message (step S144), the connection control section 131 of the management server 201 determines that the response transmitted from the telephone terminal 300-2 is the first response (step S145). Subsequently, the connection control section 131 of the management server 201 connects the telephone terminal 300-2 to the telephone terminal 300-1 corresponding to the call receiver (step S146). Thereafter, when a voice communication is established between the telephone terminal 300-2 and the telephone terminal 300-1, the recording section 150 of the management server 201 starts to record the voice communication (step S147).

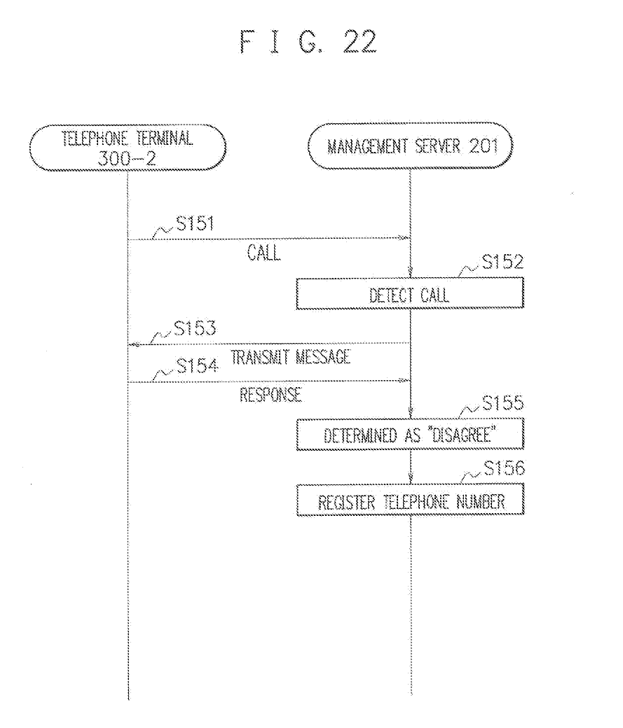

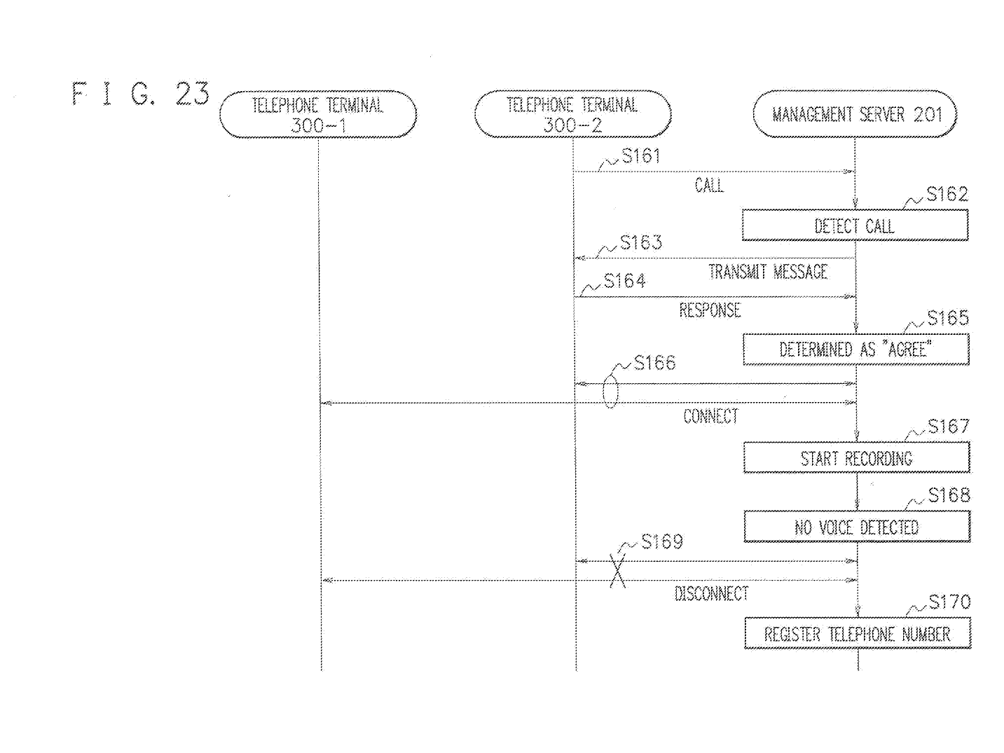

FIG. 22 is a sequence diagram for explaining processing perforated, during the processing performed by the incoming call management device 101 described with reference to FIG. 8, between the management server 201 and the telephone terminal 300-2 if the connection control section 131 determines in step S14 that the response transmitted from the telephone terminal 300-2 is the second response.

When the telephone terminal 300-2 makes a call to the telephone terminal 300-1 (step S151), the call detection section 110 of the management server 201 detects the call (step S152). Then, the message transmission section 121 of the management server 201 transmits the first message to the telephone terminal 300-2 (step S153). Thereafter, when the telephone terminal 300-2 transmits the second response corresponding to the “disagreement” as the response to the first message (step S154), the connection control section 131 of the management server 201 determines that the response transmitted from the telephone terminal 300-2 is the second response (step S155). Then, the registration section 141 of the management server 201 registers the telephone number of the telephone terminal 300-2 (step S156). In this case, the connection control section 131 of the management server 201 does not connect the telephone terminal 300-2 to the telephone terminal 300-1.

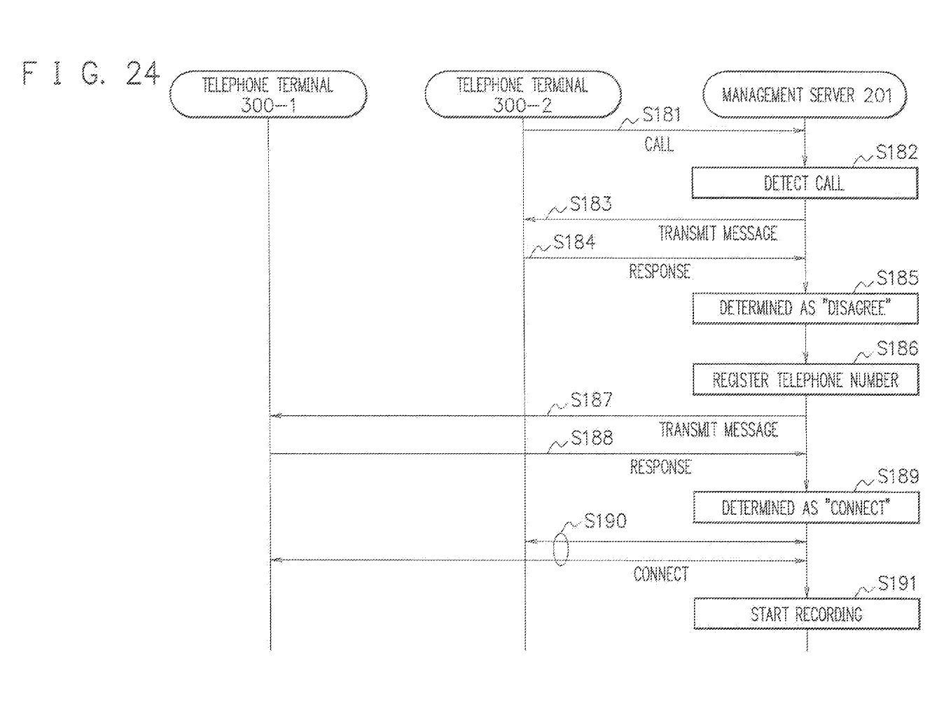

FIG. 23 is a sequence diagram for explaining processing performed, during the processing performed by the incoming call management device 101 described with reference to FIG. 12, between the management server 201 and the telephone terminals 300-1 and 300-2 if the connection control section 131 determines in step S56 that no voice has been transmitted from the telephone terminal 300-2 within the prescribed time after establishing the voice communication.

When the telephone terminal 300-2 makes a call to the telephone terminal 300-1 (step S161), the call detection section 110 of the management server 201 detects the call (step S162). Then, the message transmission section 121 of the management server 201 transmits the first message to the telephone terminal 300-2 (step S163). Thereafter, when the telephone terminal 300-2 transmits the first response corresponding to the “agreement” as the response to the first message (step S164), the connection control section 131 of the management server 201 determines that the response transmitted from the telephone terminal 300-2 is the first response (step S165). Subsequently, the connection control section 131 of the management server 201 connects the telephone terminal 300-2 to the telephone terminal 300-1 corresponding to the call receiver (step S166). Thereafter, when voice communication is established between the telephone terminal 300-2 and the telephone terminal 300-1, the recording section 150 of the management server 201 starts to record the voice communication (step S167).

Thereafter, if the connection control section 131 of the management server 201 determines that no voice has been transmitted from the telephone terminal 300-1 within the prescribed time after establishing the voice communication (step S168), connection control section 131 of the management server 201 disconnects the connection between the telephone terminal 300-2 and the telephone terminal 300-1 (step S169). Subsequently, the registration section 141 of the management server 201 registers the telephone number of the telephone terminal 300-2 (step S170).

Incidentally, the processing performed, curing the processing performed by the incoming call management device 101 described with reference to FIG. 12, between the management server 201 and the telephone terminals 300-1 and 300-2 if the connection control section 131 determines in step S53 that the response transmitted from the telephone terminal 300-2 is the second response is the same as the processing described with reference to FIG. 22. Besides, the processing performed, during the processing performed by the incoming call management device 101 described with reference to FIG. 12, between the management server 201 and the telephone terminals 300-1 and 300-2 if the connection control section 131 determines in step S56 that a voice has been transmitted from the telephone terminal 300-2 within the prescribed time after establishing, the voice communication is the same as the processing described with reference to FIG. 21.

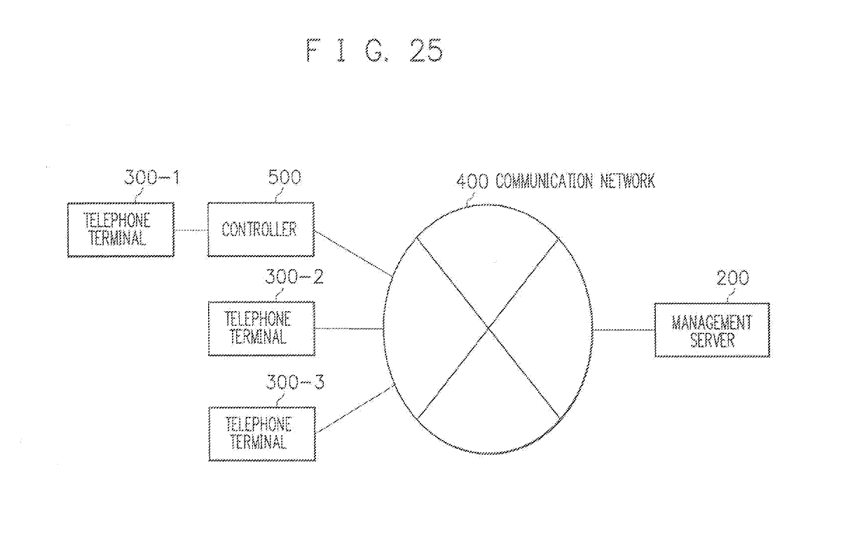

FIG. 24 is a sequence diagram for explaining processing performed, during the processing performed by the incoming call management device 101 described with reference to FIG. 14, between the management server 201 and the telephone terminals 300-1 and 300-2 if the connection control section 131 determines in step S86 that the response transmitted from the telephone terminal 300-1 is the third response.

When the telephone terminal 300-2 makes a call to the telephone terminal 300-1 (step S181), the call detection section 110 of the management server 201 detects the call (step S182). Then, the message transmission section 121 of the management server 201 transmits the first message to the telephone terminal 300-2 (step S183). Thereafter, when the telephone terminal 300-2 transmits the second response corresponding to the “disagreement” as the response to the first message (step S184), the connection control section 131 of the management server 201 determines that the response transmitted from the telephone terminal 300-2 is the second response (step S185). Then, the registration section 141 of the management server 201 registers the telephone number of the telephone terminal 300-2 (step S186). Subsequently, the message transmission section 121 of the management server 201 transmits the second message to the telephone terminal 300-1 (step S187).

Thereafter, when the telephone terminal 300-1 transmits the third response in response to the second message (step S188), the connection control section 131 of the management server 201 determines that the response transmitted from the telephone terminal 300-1 in response to the second message is the third message (step S189). Then, the connection control section 131 of the management server 201 connects the telephone terminal 300-2 to the telephone terminal 300-1 (step S190). Thereafter, when a voice communication is established between the telephone terminal 300-2 and the telephone terminal 300-1, the recording section 150 of the management server 201 starts to record the voice communication (step S191).

The processing performed, during the processing performed by the incoming call management device 101 described with reference to FIG. 14, between the management server 201 and the telephone terminals 300-1 and 300-2 if the connection control section 131 determines in step S83 that the response transmitted from the telephone terminal 300-2 is the first response is the same as the processing described with reference to FIG. 21. Besides, during the processing performed by the incoming call management device 101 described with reference to FIG. 14, if the connection control section 131 determines in step S86 that the response transmitted from the telephone terminal 300-2 is not the third response, the processing is terminated without connecting the telephone terminal 300-2 to the telephone terminal 300-1 by the connection control section 131 of the management server 201.

In this manner, the management server 201 that relays voice calls between telephone terminals and manages telephone terminals of subscribers to a service is provided with the incoming call management device 101 described in the second embodiment. When the management server 201 detects a voice communication call, a prescribed message is transmitted to the call originator, and if an affirmative response is received in response to the message, the call is connected and a voice communication is recorded. Alternatively, if a negative response is received, the management server 201 registers the telephone number of the calling terminal. When the registered telephone number meets a prescribed condition, the management server 201 rejects a connection from the telephone terminal having that telephone number. Owing to this configuration, even if a user of a telephone terminal having an incoming call does not input a telephone number of a call originator by himself/herself, registration of the telephone number is triggered by disagreement of the call originator on the recording of a voice communication, and the connection block list corresponding to a list of telephone numbers of call originators for rejecting a connection can be created. By utilizing this connection block list, a user can be prevented from becoming a victim of a nuisance call.

### Fourth Embodiment

FIG. 25 is a diagram illustrating a fourth embodiment of the incoming call management device of the present invention.

As illustrated in FIG. 25, a communication system of the present embodiment is provided with a management server 200, telephone terminals 300-1 to 300-3 and a controller 500. Besides, the management server 200, the controller 500, the telephone terminals 300-2 and 300-3 are mutually connected via a communication network 400. Furthermore, the controller 500 is connected between the communication network 400 and the telephone terminal 300-1. Although the number of telephone terminals 300-1 to 300-3 is three in the embodiment illustrated in FIG. 25, the number is not specified.

Each of the telephone terminals 300-1 to 300-3 is communication equipment capable of making a voice call. Each of the telephone terminals 300-1 to 300-3 is not limited to a landline telephone but may be any communication equipment such as a cellular phone, a portable terminal, a smart phone or a tablet terminal.

The management server 200 relays voice calls between the telephone terminals 300-1 to 300-3 via the communication network 400. Besides, the management server 200 is a server for providing a prescribed service and manages telephone terminals of subscribers to the service.

The controller 500 is connected between the communication network 400 and the telephone terminal 300-1, and controls communication from the communication network 400 to the telephone terminal 300-1.

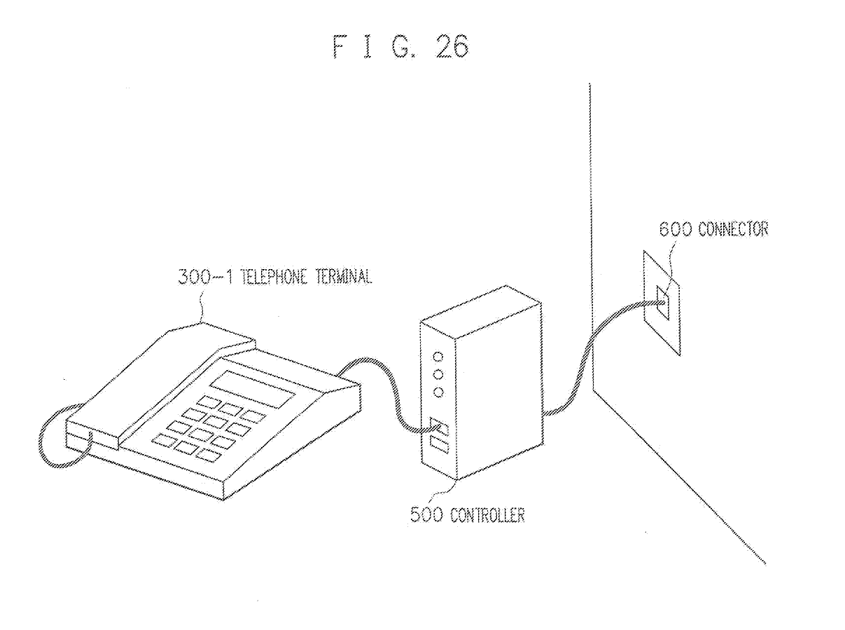

FIG. 26 is a diagram illustrating an exemplified connection of the controller 500 of FIG. 25.

As illustrated in FIG. 26, the controller 500 of FIG. 25 is connected via a communication cable to, for example, a connector 600, that is, a connection point to the communication network 400, provided on an indoor wall or the like. The controller 500 is connected also to the telephone terminal 300-1 via a communication cable. Besides, the controller 500 and the telephone terminal 300-1 may be configured to be able to make wireless communication via wireless LAN (local area network) Bluetooth (registered trademark) or the like.

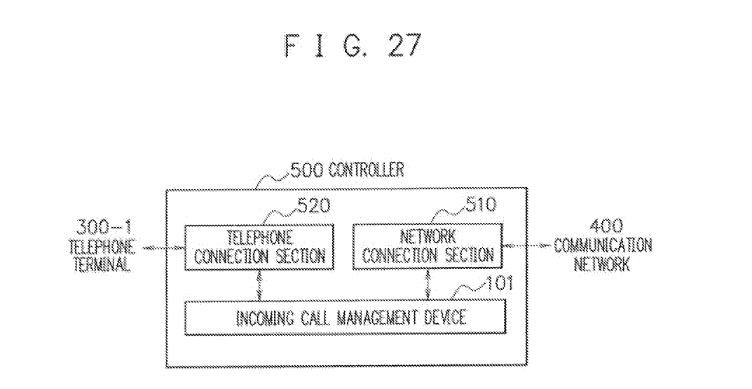

FIG. 27 is a diagram illustrating an exemplified internal configuration of the controller 500 of FIG. 25.

The controller 500 of FIG. 25 includes, as illustrated in FIG. 27, a network connection section 510, a telephone connection section 520, and an incoming call management device 101. Incidentally, FIG. 27 illustrates merely exemplary principal composing elements pertaining to the present embodiment out of all composing elements of the controller 500 of FIG. 25. Incidentally, the controller 500 may include composing elements of the incoming call management device 101 as hardware, or may store a program for realizing the incoming call management device.

The network connection section 510 has an interface function with the communication network 400, and transmits/receives data to/from the telephone terminals 300-2 and 300-3 and the management server 200 connected to the communication network 400.

The telephone connection section 520 has an interface function with the telephone terminal 300-1, and transmits/receives data to/front the telephone terminal 300-1.

The incoming call management device 101 is the same as that described in the second embodiment.

Now, an incoming call control method employed in the embodiment illustrated in FIG. 25 will be described. Herein, the description will be given on the assumption that the telephone terminal 300-2 makes a call to the telephone terminal 300-1 in the communication system illustrated in FIG. 25. The processing performed by the incoming call management device 101 included in the controller 500 of FIG. 25 is the same as that described in the second embodiment with reference to FIGS. 8, 12, 14, 16 and 17. Besides, the transmission/receipt of a message or a response described below is performed via the management server 200, which is not herein illustrated.

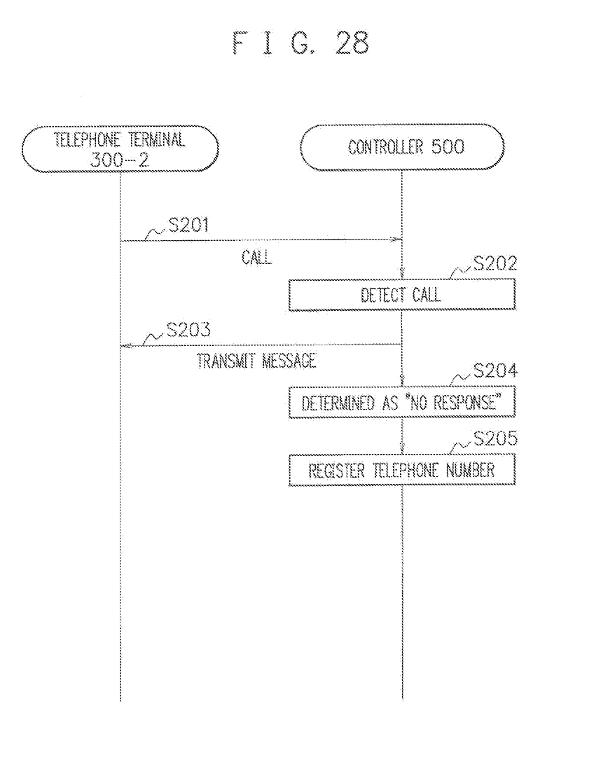

FIG. 28 is a sequence diagram for explaining processing performed, during the processing performed by the incoming call management device 101 described with reference to FIG. 8, between the controller 500 and the telephone terminal 300-2 if the connection control section 131 determines in step S13 that neither the first response nor the second response has been transmitted within the prescribed time.

When the telephone terminal 300-2 makes a call to the telephone terminal 300-1 (step S201), the call detection section 110 of the controller 500 detects the call (step S202). Then, the message transmission section 121 of the controller 500 transmits the first message to the telephone terminal 300-2 (step S203). Subsequently, if the connection control section 131 of the controller 500 determines that neither the first response nor the second response has been transmitted from the telephone terminal 300-2 within the prescribed time (step S204), the registration section 141 of the controller 500 registers the telephone number of the telephone terminal 300-2 (step S205). In this case, the connection control section 131 of the controller 500 does not connect the telephone terminal 300-2 to the telephone terminal 300-1.

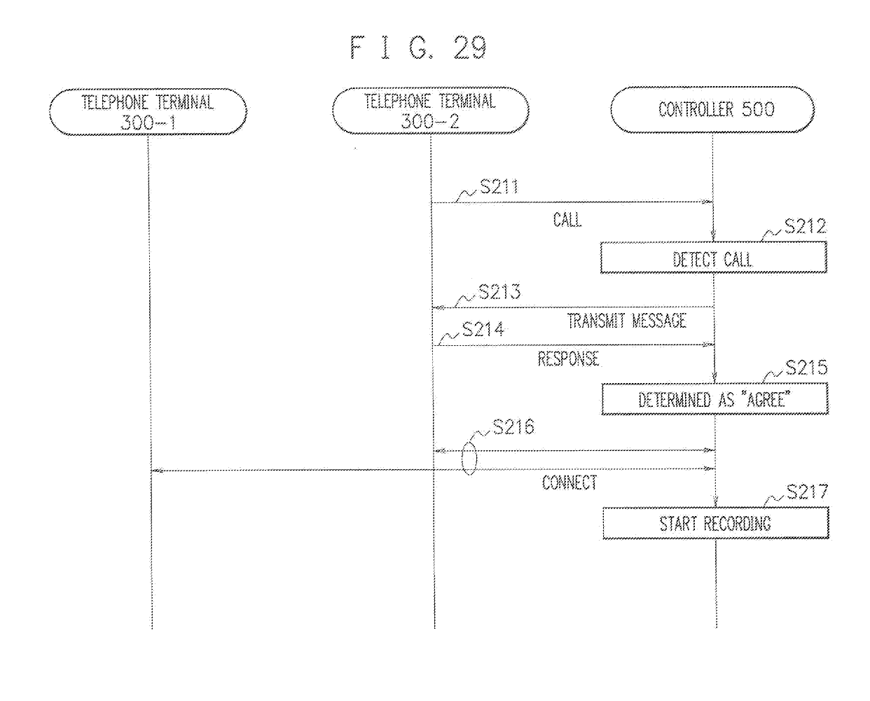

FIG. 29 is a sequence diagram for explaining processing performed, during the processing performed by the incoming call management device 101 described with reference to FIG. 8, between the controller 500 and the telephone terminals 300-1 and 300-2 if the connection control section 131 determines in step S14 that the response transmitted from the telephone terminal 300-2 is the first response.

When the telephone terminal 300-2 makes a call to the telephone terminal 300-1 (step S211), the call detection section 110 of the controller 500 detects the call (step S212). Then, the message transmission section 121 of the controller 500 transmits the first message to the telephone terminal 300-2 (step S213). Thereafter, if the telephone terminal 300-2 transmits the first response corresponding to the “agreement” as the response to the first message (step S214), the connection control section 131 of the controller 500 determines that the response transmitted, from the telephone terminal 300-2 is the first response (step S215). Subsequently, the connection control section 131 of the controller 500 connects the telephone terminal 300-2 to the telephone terminal 300-1 corresponding to the call receiver (step S216). Thereafter, when a voice communication is established between the telephone terminal 300-2 and the telephone terminal 300-1, the recording section 150 of the controller 500 starts to record the voice communication (step S217).

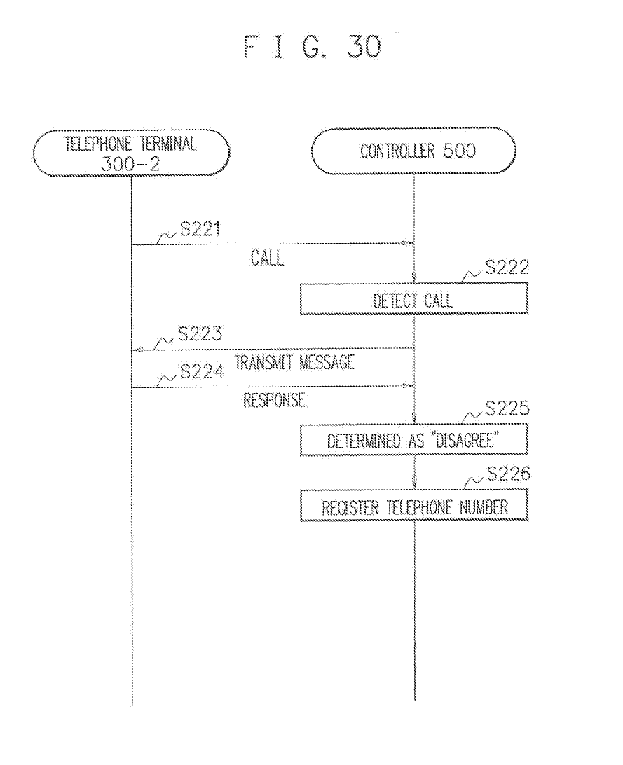

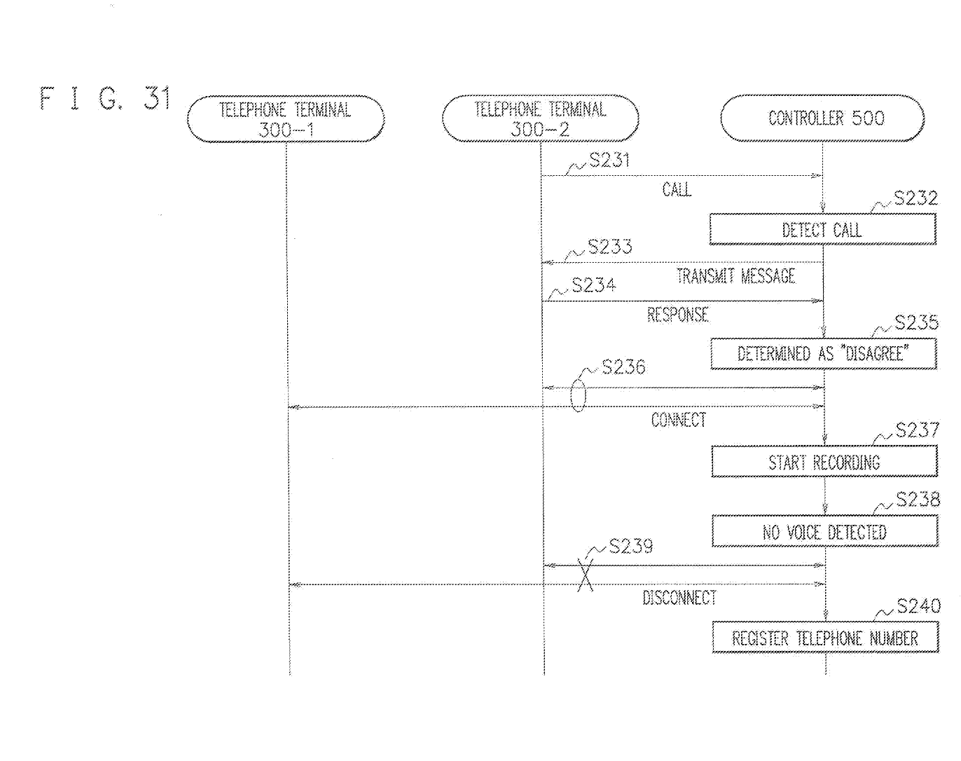

FIG. 30 is a sequence diagram for explaining processing performed, during the processing performed by the incoming call management device 101 described with reference to FIG. 8, between the controller 500 and the telephone terminal 300-2 if the connection control section 131 determines in step S14 that the response transmitted from the telephone terminal 300-2 is the second response.

When the telephone terminal 300-2 makes a call to the telephone terminal 300-1 (step S221), the call detection section 110 of the controller 500 detects the call (step S222). The message transmission section 121 of the controller 500 transmits the first message to the telephone terminal 300-2 (step S223). Thereafter, when the telephone terminal 300-2 transmits the second response corresponding to the “disagreement” as the response to the first message (step S224), the connection control section 131 of the controller 500 determines that the response transmitted from the telephone terminal 300-2 is the second response (step S225). Then, the registration section 141 of the controller 500 registers the telephone number of the telephone terminal 300-2 (step S224). In this case, the connection control section 131 of the controller 500 does not connect the telephone terminal 300-2 to the telephone terminal 300-1.

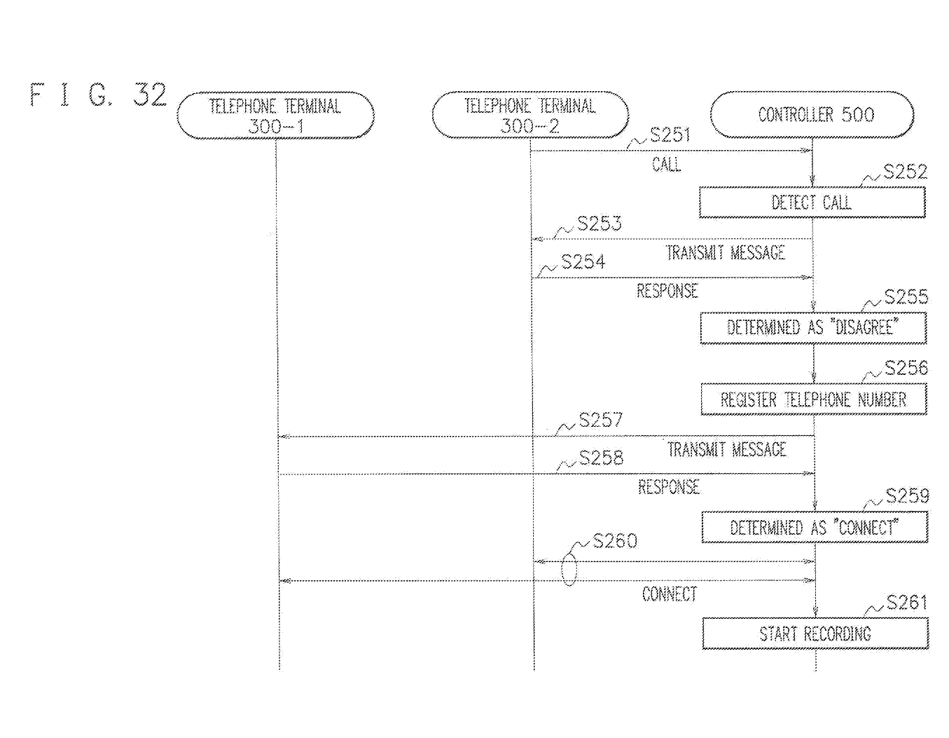

FIG. 31 is a sequence diagram for explaining processing performed, during the processing performed by the incoming call management device 101 described with reference to FIG. 12, between the controller 500 and the telephone terminals 300-1 and 300-2 if the connection control section 131 determines in step S56 that no voice has been transmitted from the telephone terminal 300-2, within the prescribed time after establishing the voice communication.

When the telephone terminal 300-2 makes a call to the telephone terminal 300-1 (step S231), the call detection section 110 of the controller 500 detects the call (step S232). The message transmission section 121 of the controller 500 transmits the first message to the telephone terminal 300-2 (step S233). Thereafter, when the telephone terminal 300-2 transmits the first response corresponding to the “agreement” as the response to the first message (step S234), the connection control section 131 of the controller 300 determines that the response transmitted from the telephone terminal 300-3 is the first response (step S235). Subsequently, the connection control section 131 of the controller 500 connects the telephone terminal 300-2 to the telephone terminal 300-1 corresponding to the call receiver (step S230). Thereafter, when a voice communication is established between the telephone terminal 300-2 and the telephone terminal 300-1, the recording section 150 of the controller 500 starts to record the voice communication (step S237).

Thereafter, if the connection control section 131 of the controller 500 determines that no voice has been transmitted from the telephone terminal 300-2 within the prescribed time after establishing the voice communication (step S238), the connection control section 131 of the controller 500 disconnects the connection between the telephone terminal 300-2 and the telephone terminal 300-1 (step S239). Subsequently, the registration section 141 of the controller 500 registers the telephone number of the telephone terminal 300-2 (step S240).

Incidentally, the processing performed, during the processing performed by the incoming call management device 101 described with reference to FIG. 12, between the controller 500 and the telephone terminal 300-2 if the connection control section 131 determines in step S53 that the response transmitted from the telephone terminal 300-2 is the second response is the same as the processing described with reference to FIG. 30. Besides, the processing performed, during the processing performed by the incoming call management device 101 described with reference to FIG. 12, between the controller 500 and the telephone terminals 300-1 and 300-2 if the connection control section 131 determines in step S56 that a voice has been transmitted from the telephone terminal 300-2 within the prescribed time after establishing the voice communication is the same as the processing described with reference to FIG. 29.

FIG. 32 is a sequence diagram for explaining processing performed, during the processing performed by the incoming call management device 101 described with reference to FIG. 14, between the controller 500 and the telephone terminals 300-1 and 300-2 if the connection control section 131 determines in step S86 that the response transmitted from the telephone terminal 300-1 is the third response.

When the telephone terminal 300-2 makes a call to the telephone terminal 300-1 (step S251), the call detection section 110 of the controller 500 detects the call (step S252). Then the message transmission section 121 of the controller 500 transmits the first message to the telephone terminal 300-2 (step S253). Thereafter, when the telephone terminal 300-2 transmits the second response corresponding to the “disagreement” as the response to the first message (step S254), the connection control section 131 of the controller 500 determines that the response transmitted from the telephone terminal 300-2 is the second response (step S255). Then, the registration section 141 of the controller 500 registers the telephone number of the telephone terminal 300-2 (step S256). Subsequently, the message transmission section 121 of the controller 500 transmits the second message to the telephone terminal 300-1 (step S257).

Thereafter, when the telephone terminal 300-1 transmits the third response in response to the second message (step S258) the connection control section 131 of the controller 500 determines that the response transmitted from the telephone terminal 300-1 in response to the second message is the third response (step S259). Then, the connection control section 131 of the controller 500 connects the telephone terminal 300-2 to the telephone terminal 300-1 (step S260). Thereafter, when a voice communication is established between the telephone terminal 300-2 and the telephone terminal 300-1, the recording section 150 of the controller 500 starts to record the voice communication (step S261).

The processing performed, during the processing performed by the incoming call management device 101 described with reference to FIG. 14, between the controller 500 and the telephone terminals 300-1 and 300-2 if the connection control section 131 determines in step S83 that the response transmitted from the telephone terminal 300-2 is the first response is the same as the processing described with reference to FIG. 29. Besides, during the processing performed by the incoming call management device 101 described with reference to FIG. 14, if the connection control section 131 determines in step S86 that the response transmitted from the telephone terminal 300-1 is not the third response, the processing is terminated without connecting the telephone terminal 300-2 to the telephone terminal 300-1 by the connection control section 131 of the controller 500.

Incidentally, the controller 500 may transmit the telephone number list and the connection block list registered in the registration section 141 to the management server 200 at a prescribed timing, so as to manage these lists in the management server 200. In this case, the management server 200 performs the processing described with reference to FIGS. 16 and 17. Besides, the management server 200 may delete a telephone number registered in the telephone number list or the connection block list when a prescribed time has elapsed since the registration of this telephone number in the telephone number list or the connection block list. Alternatively, the management server 200 may delete all telephone numbers registered in the telephone number list or the connection block list at a prescribed cycle or timing. Besides, if another controller 500 is also connected to a different telephone terminal, the management server 200 may transmit the telephone number list and the communication block list managed by itself to this controller connected to the different telephone terminal at a prescribed timing.

In this manner, the controller 500 connected between a telephone terminal that can be a receiving terminal and the communication network 400 is provided with the incoming call management device 101 described in the second embodiment. When the controller 500 detects a voice communication call, a prescribed message is transmitted to the call originator, and if an affirmative response is received in response to the message, the call is connected and a voice communication is recorded. Alternatively, if a negative response is received, the controller 500 registers the telephone number of the calling terminal. When the registered telephone number meets a prescribed condition, the controller 500 rejects a connection from the telephone terminal having that telephone number. Owing to this configuration, even if a user of a telephone terminal having an incoming call does not input a telephone number of a call originator by himself/herself, registration of the telephone number is triggered by disagreement of the call originator on the recording of a voice communication, and the connection block list corresponding to a list of telephone numbers of call originators for rejecting a connection can be created. By utilizing this connection block list, a user can be prevented from becoming a victim of a nuisance call.

### Fifth Embodiment

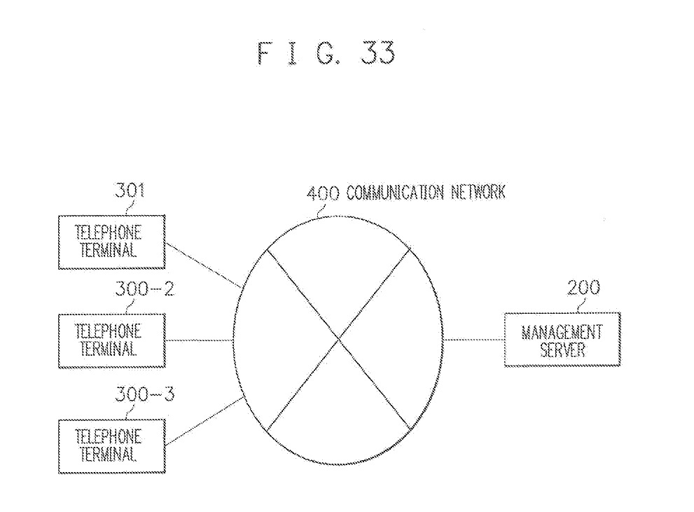

FIG. 33 is a diagram illustrating a fifth embodiment of the incoming call management device of the present invention. In the present embodiment, a telephone terminal that can be a receiving terminal is provided with the incoming call management device. In the present embodiment, the telephone terminal may include composing elements of the incoming call management device as hardware, or may store a program for realizing the incoming call management device.

As illustrated in FIG. 33, a communication system of the present embodiment includes a management server 200 and telephone terminals 301, 300-2 and 300-3. Besides, the management server 200 and the telephone terminals 301, 300-2 and 300-3 are mutually connected via a communication network 400. Furthermore, although the number of telephone terminals 301, 300-2 and 300-3 is three in the embodiment illustrated in FIG. 33, the number is not specified.

Each of the telephone terminals 301, 300-2 and 300-3 is communication equipment capable of making a voice call. Each of the telephone terminals 301, 300-2 and 300-3 is not limited to a landline telephone but may be any communication equipment such as a cellular phone, a portable terminal, a smart phone or a tablet terminal.

The management server 200 relays voice calls between the telephone terminals 301, 300-2 and 300-3 via the communication network 400. Besides, the management server 200 is a server for providing a prescribed service, and manages telephone terminals of subscribers to the service.

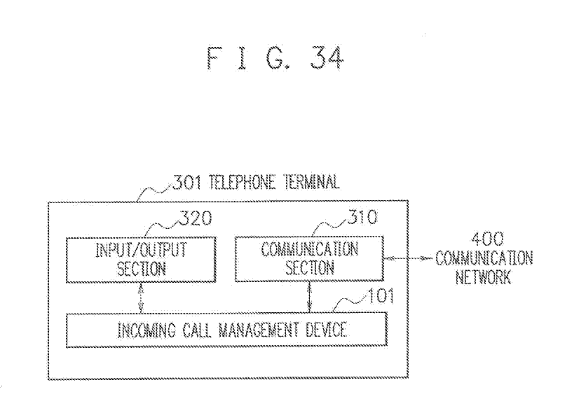

FIG. 34 is a diagram illustrating an exemplified internal configuration of the telephone terminal 301 of FIG. 33.

The telephone terminal 301 of FIG. 33 includes, as illustrated in FIG. 34, a communication section 310, an input/output section 320 and an incoming call management device 101. Incidentally, FIG. 34 illustrates merely exemplary principal composing elements pertaining to the present embodiment out of all composing elements of the telephone terminal 301 of FIG. 33.

The communication section 310 has an interface function with the communication network 400, and transmits/receives data to/from the telephone terminals 300-2 and 300-3 and the management server 200 connected to the communication network 400.

The input/output section 320 inputs information to the telephone terminal 301 on the basis of an operation performed by a user using the telephone terminal 301 and outputs information for the user using the telephone terminal 301. The input/output section 320 consists of, for example, an input part including a microphone, a button key, a touch panel and the like and an output part including is speaker, a display and the like.

The incoming call management device 101 is the same as that described in the second embodiment.

Now, an incoming call control method employed in the embodiment of FIG. 33 will be described. The transmission/receipt of a message or a response described below is performed via the management server 200, which is herein not illustrated. First, processing performed by the incoming call management device 101 of the telephone terminal 301 from the detection of a call until the registration of a telephone number will be described with reference to three examples. Herein, the description will be given on the assumption that the telephone terminal 300-2 makes a call to the telephone terminal 301 in the communication system illustrated in FIG. 33.

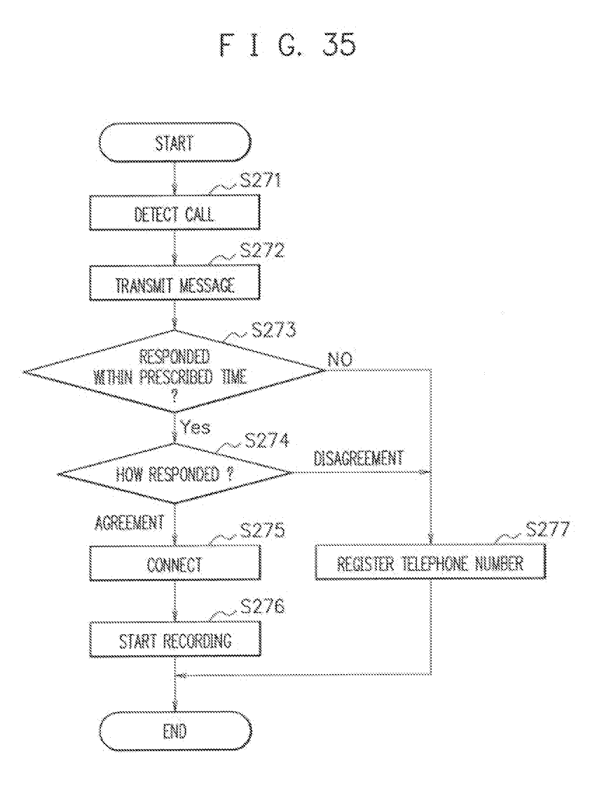

FIG. 35 is a flowchart for explaining a first example of the processing performed by the incoming call management device 101 of the telephone terminal 301 of FIG. 34 from the detection of a call until the registration of a telephone number.

First, when the call detection section 110 of the telephone terminal 301 detects a voice communication call (step S271), the message transmission section 121 of the telephone terminal 301 transmits the first message to the telephone terminal 300-2, that is, the calling terminal making the call (step S272). Thereafter, the connection control section 131 of the telephone terminal 301 determines whether or not the first response (of agreement) or the second response (of disagreement) has been transmitted from the telephone terminal 300-2 within a prescribed time after the message transmission section 121 of the telephone terminal 301 transmitted the first message (step S273). This prescribed time is information that is precedently stored in the telephone terminal 301 and can be externally set/changed.

If the connection control section 131 of the telephone terminal 301 determines that the first response or the second response has been transmitted from the telephone terminal 300-2 within the prescribed time, the connection control section 131 of the telephone terminal 301 determines which of the first response and the second response the transmitted response is (step S274).

If the connection control section 131 of the telephone terminal 301 determines that the response transmitted from the telephone terminal 300-2 is the first response, the connection control section 131 of the telephone terminal 301 connects the telephone terminal 300-2 to the telephone terminal 301 (step S275). Here, the connection control section 131 of the telephone terminal 301 connects the telephone terminal 300-2 to the telephone terminal 301 by causing the input/output section 320 to output information corresponding to the receipt of a voice call. For example, the connection control section 131 of the telephone terminal 301 causes the input/output section 320 to output a prescribed sound or to display prescribed information. Thereafter, when a user of the telephone terminal 301 off-hooks the telephone terminal 301 to establish a voice communication between the telephone terminal 300-2 and the telephone terminal 301, the recording section 150 of the telephone terminal 301 starts to record the voice communication (step S276).

On the other hand, if the connection control section 131 of the telephone terminal 301 determines in step S273 that neither the first response nor the second response has been transmitted from the telephone terminal 300-2 within the prescribed time, the registration section 141 of the telephone terminal 301 registers the telephone number of the telephone terminal 300-2 (step S277). In this case, the connection control section 131 of the telephone terminal 301 does not connect the telephone terminal 300-2 to the telephone terminal 301. Also when the response transmitted from the telephone terminal 300-2 is determined as the second response in step S274, the connection control section 131 of the telephone terminal 301 does not connect the telephone terminal 300-2 to the telephone terminal 301, and the registration section 141 of the telephone terminal 301 registers the telephone number of the telephone terminal 300-2 in step S277.

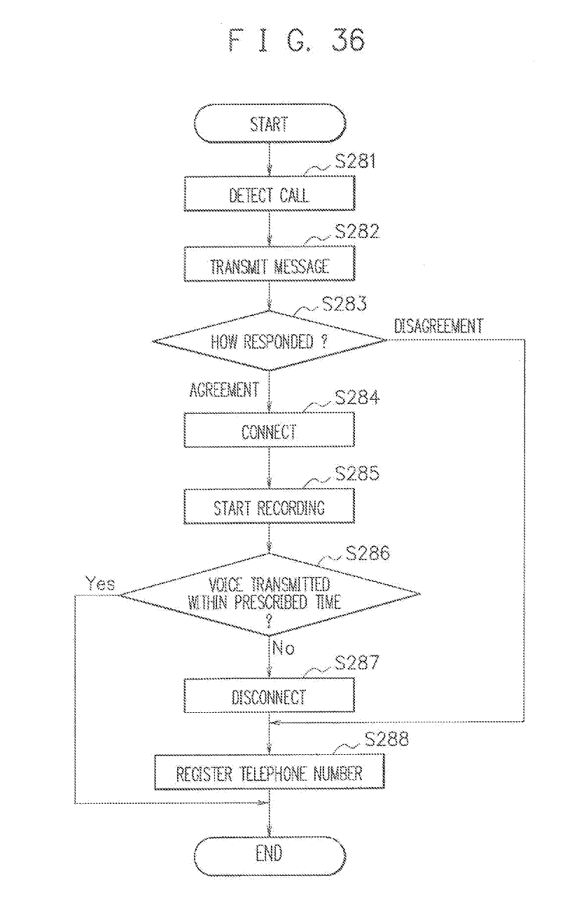

FIG. 36 is a flowchart for explaining a second example of the processing performed by the incoming call management device 101 of the telephone terminal 301 of FIG. 34 from the detection of a call until the registration of a telephone number.

First, when the call detection section 110 of the telephone terminal 301 detects a voice communication call (step S281), the message transmission section 121 of the telephone terminal 301 transmits the first message to the telephone terminal 300-2 corresponding to the call originator (step S282). Thereafter, the connection control section 131 of the telephone terminal 301 determines which of the first response and the second response a response transmitted from the telephone terminal 300-2 in response to the first message transmitted by the message transmission section 121 of the telephone terminal 301 is (step S283).

If the response transmitted from the telephone terminal 300-2 is determined as the first response, the connection control section 131 of the telephone terminal 301 connects the telephone terminal 300-2 to the telephone terminal 301 corresponding to the call receiver (step S284). The connection method is the same as that described above. Thereafter, when the user of the telephone terminal 301 off-hooks the telephone terminal 301 to establish a voice communication between the telephone terminal 300-2 and the telephone terminal 301, the recording section 150 of the telephone terminal 301 starts to record the voice communication (step S285).

After the voice communication is established between the telephone terminal 300-2 and the telephone terminal 301, the connection control section 131 of the telephone terminal 301 determines whether or not a voice has been transmitted from the telephone terminal 300-2 within a prescribed time (step S286). This prescribed time is precedently stored in the telephone terminal 301 and can be externally set/changed. If the connection control section 131 of the telephone terminal 301 determines that no voice has been transmitted from the telephone terminal 300-2 within the prescribed time after establishing the voice communication, the connection control section 131 of the telephone terminal 301 disconnects the connection between the telephone terminal 300-2 and the telephone terminal 301 (step S287). Subsequently, the registration section 141 of the telephone terminal 301 registers the telephone number of the telephone terminal 300-2 (step S288).

On the other hand, if it is determined in step S283 that the response transmitted from the telephone terminal 300-2 is the second response, the connection control section 131 of the telephone terminal 301 does not connect the telephone terminal 300-2 to the telephone terminal 301, and the registration section 141 of the telephone terminal 301 registers the telephone number of the telephone terminal 300-2 in step S288.

Besides, if the connection control section 131 of the telephone terminal determines in step S28 that a voice has been transmitted from the telephone terminal 300-2 within the prescribed time after establishing the voice communication, the connection control section 131 of the telephone terminal 301 does not disconnect the connection between the telephone terminal 300-2 and the telephone terminal 301.

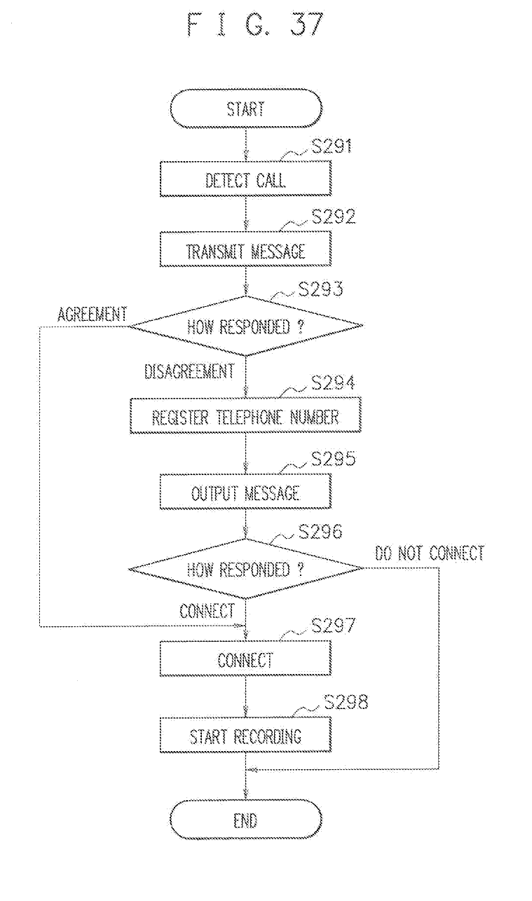

FIG. 37 is a flowchart for explaining a third example of the processing performed by the incoming call management device 101 of the telephone terminal 301 of FIG. 34 from the detection of a call until the registration of a telephone number.

First, when the call detection section 110 of the telephone terminal 301 detects a voice communication call (step S291), the message transmission section 121 of the telephone terminal 301 transmits the first message to the telephone terminal 300-2, that is, the calling terminal making the call (step S292). Thereafter, the connection control section 131 of the telephone terminal 301 determines which of the first response and the second response a response transmitted from the telephone terminal 300-2 in response to the first message transmitted by the message transmission section 121 of the telephone terminal 301 is (step S293).

If the message transmitted from the telephone terminal 300-2 is the second response, the registration section 141 of the telephone terminal 301 registers the telephone number of the telephone terminal 300-2 (step S294). Subsequently, the message transmission section 121 of the telephone terminal 301 transmits the second message to the input/output section 320. Then, the input/output section 320 outputs the second message having been output from the message transmission section 121 to the outside of the telephone terminal 301 (step S295). As a method for outputting this message from the input/output section 320, the input/output section 320 may output a message for confirming whether or not the call may be connected although the calling terminal does not agree to the recording, or may display this message. Besides, the input/output section 320 preferably outputs information for causing a user to select either “connect” or “not connect” at this point.

Thereafter, when the user of the telephone terminal 301 performs on operation for inputting a response to the second message to the input/output section 320, the input/output section 320 outputs this response to the connection control section 131. The second message and a response to the second message are input/output in the same manner as the transmission/receipt of the second message and the response to the second message described in the first embodiment. Then, the connection control section 131 of the telephone terminal 301 determines whether or not the response output from the input/output section 320 is the third response (step S296).

If the connection control section 131 of the telephone terminal 301 determines that the response output from the input/output section 320 is the third response, the connection control section 131 connects the telephone terminal 300-2 to the telephone terminal 301 (step S297). The connecting method is the same as that described above. Thereafter, when a voice communication is established between the telephone terminal 300-2 and the telephone terminal 301, the recording section 150 of the telephone terminal 301 starts to record the voice communication (step S298).

On the other hand, if the connection control section 131 of the telephone terminal 301 determines in step S293 that the response transmitted from the telephone terminal 300-2 is the first response, the connection control section 131 connects the telephone terminal 300-2 to the telephone terminal 301 corresponding to the call receiver in step S297. Thereafter, when the user of the telephone terminal 301 off-hooks the telephone terminal 301 to establish a voice communication between the telephone terminal 300-2 and the telephone terminal 301, the recording section 150 of the telephone terminal 301 starts to record the voice communication in step S298.

Besides, if the connection control section 131 of the telephone terminal 301 determines in step S296 that the response output from the input/output section 320 is not the third response, namely, the response output front the input/output section 320 is a response not requiring the connection, the connection control section 131 of the telephone terminal 301 does not connect the telephone terminal 300-2 to the telephone terminal 301. Besides, also when no response has been output from the input/output section 320 in response to the second message even if a prescribed time has elapsed since the message transmission section 121 of the telephone terminal 301 output the second message, the connection control section 131 of the telephone terminal 301 does not connect the telephone terminal 300-2 to the telephone terminal 301.

Incidentally, it the call detection section 110 of the telephone terminal 301 detects a call from a telephone terminal having a telephone number registered in an address book included in the telephone terminal 301, the message transmission section 121 of the telephone terminal 301 may not transmit the first message. In this case, the connection control section 131 of the telephone terminal 301 connects the telephone terminal having this telephone number to the telephone terminal 301.

In the incoming call control method employed in the fifth embodiment, the processing for registering a telephone number in the connection block list by the incoming call management device 101 of the telephone terminal 301 and the processing for rejecting a connection from the telephone terminal 300-2 or 300-3 are the same as those described in the second embodiment.

Incidentally, the telephone terminal 301 may transmit the telephone number list and the connection block list registered in the registration section 141 to the management server 200 at a prescribed timing, so that these lists can be managed by the management server 200. In this case, the management server 200 performs the processing described with reference to FIGS. 16 and 17. Besides, the management server 200 may delete a telephone number registered in the telephone number list or the connection block list when a prescribed time has elapsed since the registration of this telephone number in the telephone number list or the connection block list. Alternatively, the management server 200 may delete all telephone numbers registered in the telephone number list or the connection block list at a prescribed cycle or timing. Furthermore, the management server 200 may transmit the telephone number list and the connection block list managed by itself to another telephone terminal at a prescribed timing.

In this manner, the telephone terminal that can be a receiving terminal is provided with the incoming call management device 101 described in the second embodiment. When the receiving terminal detects a voice communication call, a prescribed message is transmitted to the call originator, and if an affirmative response is received in response to the message, the call is connected and a voice communication is recorded. Alternatively, if a negative response is received, the receiving terminal registers the telephone number of the calling terminal. When the registered telephone number meets a prescribed condition, the receiving terminal rejects a connection from the telephone terminal having that telephone number. Owing to this configuration, even if a user of a telephone terminal having an incoming call does not input a telephone number of a call originator by himself/herself, registration of the telephone number is triggered by disagreement of the call originator on the recording of a voice communication, and the connection block list corresponding to a list of telephone numbers of call originators for rejecting a connection can be created. By utilizing this connection block list, a user can be prevented from becoming a victim of a nuisance call.

The processing performed by each of the incoming call management devices 100 and 101, the management server 201, the controller 500 and the telephone terminal 301 described above may be carried out by using a logic circuit constructed for each purpose. Alternatively, a computer program (hereinafter simply referred to as the program) describing the contents of each processing may be recorded in a recording medium readable by the incoming call management device 100 or 101, the management server 201, the controller 500 or the telephone terminal 301, so that the program recorded in the recording medium can be read and executed by the incoming call management device 100 or 101, the management server 201, the controller 500 or the telephone terminal 301. The recording medium readable by the incoming call management device 100 or 101, the management server 201, the controller 500 or the telephone terminal 301 refers to a removable recording medium such as a floppy (registered trademark) disk, a magneto-optical disk, a DVD (digital versatile disk) or a CD (compact disk), or a memory such as a ROM (read only memory) or a RAM (random access memory) or an HDD (hard disk drive) built in the incoming call management device 100 or 101, the management server 201, the controller 500 or the telephone terminal 301. The program recorded in this recording medium is read by a CPU (central processing unit) (not shown) provided in the incoming call management device 100 or 101, the management server 201, the controller 500 or the telephone terminal 301, so as to perform the processing as described above under control of the CPU. Here, the CPU operates as a computer for executing a program read from a recording medium in which the program is recorded.

A part or the whole of the above-described embodiment can be described also as, but not limited to, the following notes:

(Note 1) An incoming call management device including: a call detection section detecting a voice communication call; a message transmission section transmitting a first message to a calling terminal corresponding to an originator of the call when the call detection section detects the call; a connection control section connecting the calling terminal to a receiving terminal corresponding to a receiver of the call if a first response is transmitted from the calling terminal in response to the first message transmitted by the message transmission section, and rejects a connection of the calling terminal to the receiving terminal if a second response is transmitted from the calling terminal in response to the first message transmitted by the message transmission section; and a registration section registering a telephone number of the calling terminal if the second response is transmitted from the calling terminal in response to the first message transmitted by the message transmission section.

(Note 2) The incoming call management device according to Note 1 above, in which the connection control section rejects the connection of the calling terminal to the receiving terminal if neither the first response nor the second response is transmitted from the calling terminal within a prescribed time after transmitting the first message by the message transmission section, and the registration section registers the telephone number of the calling terminal if neither the first response nor the second response is transmitted from the calling terminal within the prescribed time after transmitting the first message by the message transmission section.

(Note 3) The incoming call management device according to Note 1 or Note 2 above, which the connection control section disconnects the connection if no voice is transmitted from the calling terminal within a prescribed time after establishing a voice communication between the calling terminal and the receiving terminal after connecting the calling terminal to the receiving terminal, and the registration section registers the telephone number of the calling terminal if the connection control section disconnects the connection.

(Note 4) The incoming call management device according to any one of Note 1 to Note 3, in which the message transmission section transmits a second message to the receiving terminal if the second response is transmitted from the calling terminal, and the connection control section connects the calling terminal to the receiving terminal if a prescribed third response is transmitted from the receiving terminal in response to the second message transmitted by the message transmission section.

(Note 5) The incoming call management device according to any one of Note 1 to Note 4, in which if a telephone number registered by the registration section meets a prescribed condition, the connection control section rejects a connection from a telephone terminal having the telephone number.

(Note 6) The incoming call management device according to any one of Note 1 to Note 5, including a recording section recording telephone conversation of a call, in which the message transmission section transmits, as the first message, a message that telephone conversation of the call is to be recorded.

(Note 7) The incoming call management device according to any one of Note 1 to Note 6, in which if the connection control section rejects the connection, the message transmission section transmits a third message to the calling terminal.

(Note 8) The incoming call management device according to any one of Note 1 to Note 6, in which if the connection control section rejects the connection, the message transmission section transmits a ring back tone to the calling terminal.

(Note 9) The incoming call management device according to any one of Note 1 to Note 6, in which if the connection control section rejects the connection, the message transmission section transmits a busy tone to the calling terminal.

(Note 10) A management server including the incoming call management device according to any one of Note 1 to Note 9, and connected, through a communication network, to a plurality of telephone terminals including the calling terminal and the receiving terminal for relaying the voice communication call.

(Note 11) A controller including the incoming call management device according to any one of Note 1 to Note 9, and connected between the receiving terminal and a communication network.

(Note 12) A telephone terminal including the incoming call management device according to any one of Note 1 to Note 9, and capable of serving as the receiving terminal.

(Note 13) A communication system including a plurality of telephone terminals and a management server connected to the plurality of telephone terminals via a communication network, in which the management server includes: a call detection section detecting voice communication call from any of the telephone terminals; a message transmission section transmitting a first message to a calling terminal corresponding to an originator of the call, out of the plurality of telephone terminals, when the call detection section detects the call; a connection control section connecting the calling terminal to a receiving terminal corresponding to a receiver of the call, out of the plurality of telephone terminals, if a first response is transmitted from the calling terminal in response to the first message transmitted by the message transmission section, and rejects a connection of the calling terminal to the receiving terminal if a second response is transmitted from the calling terminal in response to the first message transmitted by the message transmission section; and a registration section registering a telephone number of the calling terminal if the second response is transmitted from the calling terminal in response to the first message transmitted by the message transmission section.

(Note 14) A communication system including a plurality of telephone terminals, a management server connected to the plurality of telephone terminals via a communication network, and a controller connected between one telephone terminal out of the plurality of telephone terminals and the communication network, in which the controller includes: a call detection section detecting a voice communication call from any of the plurality of telephone terminals to a receiving terminal corresponding to the telephone terminal connected to the controller out of the plurality of telephone terminals; a message transmission section transmitting a first message to a calling terminal corresponding to an originator of the call out of the plurality of telephone terminals when the call detection section detects the call; a connection control section connecting the calling terminal to the receiving terminal if a first response is transmitted from the calling terminal in response to the first message transmitted by the message transmission section, and rejects a connection of the calling terminal to the receiving terminal if a second response is transmitted from the calling terminal in response to the first message transmitted by the message transmission section; and a registration section registering a telephone number of the calling terminal if the second response is transmitted from the calling terminal in response to the first message transmitted by the message transmission section.

(Note 15) A communication system including a plurality of telephone terminals and a management server connected to the plurality of telephone terminals via a communication network for relaying voice calls between the plurality of telephone terminals in which one telephone terminal includes: a call detection section detecting a voice communication call to the telephone terminal from any one of the other telephone terminals out of the plurality of telephone terminals; a message transmission section transmitting a first message to a calling terminal corresponding to an originator of the call when the call detection section detects the call; a connection control section connecting the calling terminal to the telephone terminal if a first response is transmitted from the calling terminal in response to the first message transmitted by the message transmission section, and rejects a connection of the calling terminal to the telephone terminal if a second response is transmitted from the calling terminal in response to the first message transmitted by the message transmission section; and a registration section registering a telephone number of the calling terminal if the second response is transmitted from the calling terminal in response to the first message transmitted by the message transmission section.

(Note 16) An incoming call control method including: processing for detecting a voice communication call; processing for transmitting a first message to a calling terminal corresponding to an originator of the call if the call is detected; processing for connecting the calling terminal to a receiving terminal corresponding to a receiver of the call if a first response is transmitted from the calling terminal in response to the transmitted first message; processing for rejecting a connection of the calling terminal to the receiving terminal if a second response is transmitted from the calling terminal in response to the transmitted first message; and processing for registering a telephone number of the calling terminal if the second response is transmitted from the calling terminal in response to the first message.

(Note 17) A program for causing a computer to execute: a procedure for detecting a voice communication call; a procedure for transmitting a first message to a calling terminal corresponding to an originator of the call if the call is detected; is procedure for connecting the calling terminal to a receiving terminal corresponding to a receiver of the call if a first response is transmitted from the calling terminal in response to the transmitted first message; a procedure for rejecting a connection of the calling terminal to the receiving terminal if a second response is transmitted from the calling terminal in response to the transmitted first message; and a procedure for registering a telephone number of the calling terminal if the second response is transmitted from the calling terminal in response to the transmitted first message.

### DESCRIPTION OF REFERENCE NUMERALS

100, 101 Incoming call management device

110 Call detection section

120, 121 Message transmission section

130, 131 Connection control section

140, 141 Registration section

150 Recording section

200, 201 Management server

210 Communication relay section

220 User management section

300-1 to 300-3, 301 Telephone terminal

310 Communication section

320 Input/output section

400 Communication network

500 Controller

510 Network connection section

520 Telephone connection section

600 Connector

What is claimed is:

1. An incoming call management device comprising:
a call detection section detecting a voice communication call;
a message transmission section transmitting a first message to a calling terminal corresponding to an originator of the call when the call detection section detects the call;
a connection control section connecting the calling terminal to a receiving terminal corresponding to a receiver of the call if a first response is transmitted from the calling terminal in response to the first message transmitted by the message transmission section, and rejects a connection of the calling terminal to the receiving terminal if a second response is transmitted from the calling terminal in response to the first message transmitted by the message transmission section; and
a registration section registering a telephone number of the calling terminal if the second response is transmitted from the calling terminal in response to the first message transmitted by the message transmission section.

2. The incoming call management device according to claim 1,
wherein the connection control section rejects the connection of the calling terminal to the receiving terminal if neither the first response nor the second response is transmitted from the calling terminal within a prescribed time after transmitting the first message by the message transmission section, and
the registration section registers the telephone number of the calling terminal if neither the first response nor the second response is transmitted from the calling terminal within the prescribed time after transmitting the first message by the message transmission section.

3. The incoming call management device according to claim 1,
wherein the connection control section disconnects the connection if no voice is transmitted from the calling terminal within a prescribed time after establishing a voice communication between the calling terminal and the receiving terminal after connecting the calling terminal to the receiving terminal, and
the registration section registers the telephone number of the calling terminal if the connection control section disconnects the connection.

4. The incoming call management device according to claim 1,
wherein the message transmission section transmits a second message to the receiving terminal if the second response is transmitted from the calling terminal, and
the connection control section connects the calling terminal to the receiving terminal if a prescribed third response is transmitted from the receiving terminal in response to the second message transmitted by the message transmission section.

5. The incoming call management device according to claim 1,
wherein if a telephone number registered by the registration section meets a prescribed condition, the connection control section rejects a connection from a telephone terminal having the telephone number.

6. The incoming call management device according to claim 1, comprising a recording section recording telephone conversation of a call,
wherein the message transmission section transmits, as the first message, a message that telephone conversation of the call is to be recorded.

7. The incoming call management device according to claim 1,
wherein if the connection control section rejects the connection, the message transmission section transmits a third message to the calling terminal.

8. The incoming call management device according to claim 1,
wherein if the connection control section rejects the connection, the message transmission section transmits a ring back tone to the calling terminal.

9. The incoming call management device according to claim 1,
Wherein if the connection control section rejects the connection, the message transmission section transmits a busy tone to the calling terminal.

10. A management server comprising the incoming call management device according to claim 1, and connected, through a communication network, to a plurality of telephone terminals including the calling terminal and the receiving terminal for relaying the voice communication call.

11. A controller comprising the incoming call management device according to claim 1, and connected between the receiving terminal and a communication network.

12. A telephone terminal comprising the incoming call management device according to claim 1, and capable of serving as the receiving terminal.

13. An incoming call control method comprising:
processing for detecting a voice communication call;
processing for transmitting a first message to a calling terminal corresponding to an originator of the call if the call is detected;
processing for connecting the calling terminal to a receiving terminal corresponding to a receiver of the call if a first response is transmitted from the calling terminal in response to the transmitted first message;
processing for rejecting a connection of the calling terminal to the receiving terminal if a second response is transmitted from the calling terminal in response to the transmitted first message; and
processing for registering a telephone number of the calling terminal if the second response has been transmitted from the calling terminal in response to the first message.

14. A program for causing a computer to execute:
a procedure for detecting a voice communication call;
a procedure for transmitting a first message to a calling terminal corresponding to an originator of the call if the call is detected;
a procedure for connecting the calling terminal to a receiving terminal corresponding to a receiver of the call if a first response is transmitted from the calling terminal in response to the transmitted first message;
a procedure for rejecting a connection of the calling terminal to the receiving terminal if a second response is transmitted from the calling terminal in response to the transmitted first message; and
a procedure for registering a telephone number of the calling terminal if the second response is transmitted from the calling terminal in response to the first message.
